(19) United States
(12) Patent Application Publication
(10) Pub. No.: US 2011/0128438 A1
(43) Pub. Date: Jun. 2, 2011

(54) COLOR SIGNAL CONVERTING APPARATUS, VIDEO DISPLAYING APPARATUS, COLOR SIGNAL CONVERTING METHOD, VIDEO DISPLAYING METHOD AND IMAGE DATA

(76) Inventors: Haruo Yamashita, Osaka (JP); Yasuhiro Kuwahara, Osaka (JP); Takeshi Ito, Osaka (JP)

(21) Appl. No.: 13/055,954

(22) PCT Filed: Aug. 26, 2009
(86) PCT No.: PCT/JP2009/004106

§ 371 Date: Jan. 26, 2011

(30) Foreign Application Priority Data
Aug. 29, 2008 (JP) 2008-222078

(51) Int. Cl. H04N 11/20; H04N 11/02

(52) U.S. Cl. 348/384.1; 348/453; 348/E11.021; 348/E11.006

(57) ABSTRACT

The first color gamut conversion unit 102 limits, in a visually natural manner, an output signal to a signal within a range of the DCI color gamut through well-known color gamut conversion processing when there is a color region exceeding the DCI color gamut, the output signal being obtained through the imaging by the imaging unit 101 and represented by the primaries (R, G, and B) determined by a color filter of an image sensor of the camera. It is to be noted that a color gamut conversion technique may be any technique which can limit a color gamut such as gamut conversion processing (Non Patent Literature: “Fundamentals of Color Reproduction Engineering”, Corona Publishing Co., Ltd., pp. 178-180).

### TECHNICAL FIELD

The present invention relates to a signal processing system including a camera and a display, and particularly to (i) a color signal converting apparatus, (ii) a video displaying apparatus, (iii) a color signal converting method, and (iv) a video displaying method which process and store an image and a video each having a wide color gamut, and transmit stored image data, and (v) the image data.

### BACKGROUND ART

The recent rapid progress in display device has expanded a color range that can be represented (hereinafter, referred to as a color gamut), and allowed display devices to display vivid colors.

Currently, as color representation of consumer video apparatuses, the color representation defined in ITU-RBT. 709 (hereinafter, referred to as BT. 709), the international standard of the ITU, has been used for digital broadcasting (HDTV). Accordingly, a color gamut that can be represented by the consumer apparatuses has been limited to the color range available in the standard (hereinafter, referred to as BT. 709 color gamut). Thus, even when display devices which can display a wide color gamut are developed, the display devices cannot fulfill their original purpose of faithfully reproducing vivid colors by utilizing the wide color gamut, and the wide color gamut is confined to be used as a part of so-called image reproduction which makes colors appear vivid by increasing saturation of an image.

Merely upgrading the display devices is not sufficient to truly utilize the wide color gamut of the display devices. For the above purpose, consistent wide color gamut representation needs to be maintained in imaging, recording, transmitting, and displaying, and at the same time cameras, content creation (authoring), video formats, storage media formats, interfaces, and so on must be upgraded.

According to a video standard, a pixel color is represented by the R, G, and B primary colors (hereinafter, referred to as primaries), and the represented pixel color is converted into a luminance and chrominance format (hereinafter, referred to as a YCC format).

It is possible to transmit the wide color gamut if the R, G, and B primaries defined in the video standard are replaced with vivid R, G, and B primaries which allow representation of a wider color gamut.

However, it is difficult to change the video standard itself from a point of view of compatibility with past video standards. For instance, in the case where the three primary colors (R, G, and B) which allow a wider color gamut than the BT. 709 are added as new primaries, a new display device which can discern BT. 709 primaries and the new primaries having the wide color gamut can correctly reproduce either primaries. However, conventional display devices for which only the BT. 709 primaries is assumed cannot correctly reproduce the new primaries. When a color represented by the primaries having the wide color gamut is reproduced as the BT. 709 primaries, the color is reproduced as a faded color having low saturation. As stated above, the backward compatibility is not available for the change of the video standard itself.

In response to the above problem, xvYCC is standardized in IEC61966-2-4 as wide color gamut representation having compatibility with the BT. 709. According to the xvYCC, the BT. 709 primaries are maintained, and a color gamut is expanded by performing extension on the BT. 709 mainly in the following two manners.

First, it is acknowledged and specified that a color gamut falls within a range of almost all values of YCC represented by 8 bits used in converting R, G, and B into YCC. This is equivalent to an acknowledgement that in R, G, and B representation, a color gamut does not fall within a conventional range of 0 to 1 but takes a value below 0 and a value above 1, and it is possible to extend a color representation range. Second, a possible value range of chrominance is expanded so that a range not used according to the BT. 709 becomes available. In other words, the color gamut is further expanded by extending a range which is represented by 8 bits and within which the chrominance can fall from 16-240 to 1-254.

Because the primaries are maintained, the xvYCC is characterized by having complete compatibility with the BT. 709 with respect to a color in the BT. 709 color gamut, that is, a color having R, G, and B in a range of 0 to 1. With the backward compatibility, the color gamut is enabled to achieve the cover ratio 100% of the Munsell Color Cascade color chart (see Patent Literature 1, for example).

FIG. 19 is a diagram illustrating color representation of a conventional video signal, and shows a relationship between BT. 709 and xvYCC. The vertical axis indicates luminance (Y), and the horizontal axis indicates chrominance (Cb, Cr). Brighter color is represented as a scale on the vertical axis moves upward, and more vivid color is represented as a scale on the horizontal axis moves leftward and rightward. Furthermore, for ease in description, originally three-dimensional color representation is shown in two dimensions. Thus, two arrows in the diagram indicate the R, G, and B primaries, but mean any two of the three primaries R, G, and B.

BT. 709 primaries 905 and 906 indicate primaries in compliance with the BT. 709 standard. A parallelogram-shaped BT. 709 color gamut 901 including these two primaries is a range that can be represented when each of the primaries takes a value between 0 and 1, and indicates a color gamut that can be represented according to the BT. 709 standard. A rectangle-shaped BT. 709 region 902 surrounding the above BT. 709 color gamut 901 indicates a value range within which a luminance signal and a chrominance signal fall when a color is converted to color representation using luminance and chrominance. As is clear from the diagram, the color gamut that can be represented according to the BT. 709 standard does not fall within the entire value range of the luminance signal and the chrominance signal, and does not include the outside of the BT. 709 color gamut 901.

Moreover, a signal is composed of 8 bits in the BT. 709 standard. When a value of the signal is represented by a physical value, a logical value between 0 and 1 corresponds to a physical value between 16 and 235 in the luminance, and a logical value between −0.5 and +0.5 corresponds to an 8-bit physical value between 16 and 240 in the chrominance (Cb, Cr). Thus, both of the luminance and the chrominance does not utilize the entire range of the 8-bit values.

Here, a case is considered where the use of color representation of a full range of the BT. 709 region 902 (the outside of the BT. 709 color gamut 901 being allowed) in luminance and chrominance representation is permitted with the chromaticity and strength (the inclination and length of the two arrows in the diagram) of the primaries being maintained. Then, the color gamut is expanded towards dark and vivid color (lower triangle areas of a shaded area in the BT. 709 region 902) or bright and vivid color (upper triangle areas of the shaded area in the BT. 709 region 902). In order to represent a color gamut of the expanded BT. 709 region 902 in primary colors using the R, G, and B primaries, one or two of the R, G, and B primaries need to take a negative logical value in the lower triangle areas, the one or two of the R, G, and B primaries need to take a value above 1 as the logical value in the upper triangle areas, and the R, G, and B primaries need to exceed a range from a negative value to a value above 1.

A color gamut that can be represented is expanded more using the xvYCC than the BT. 709 by expanding, to the range from the negative value to the value above 1, a possible value range of an R, G, and B signal and allowing the use of the entire BT. 709 region 902 when the luminance and chrominance are represented, instead of maintaining the BT. 709 primaries with the above method. In the actual xvYCC, in addition to the above BT. 709 region 902, a range (a range of 1 to 254 that is almost the full range of physical values of chrominance represented by 8 bits) of an xvYCC region 903 that is not used according to the BT. 709 and can be represented according to the xvYCC is used. For this reason, the range of the physical values of the chrominance has been expanded to a range of about −0.57 to +0.56 ((254-128)/(240−128)×0.5=0.56, (128−16)×(−0.5)=−0.57).

As stated above, the BT. 709 primaries are not changed, and thus the xvYCC is compatible with the BT. 709 in terms of the color gamut of BT. 709, that is, the range of 0 to 1 within which R, G, and B fall and which is defined in the BT. 709, makes it possible to represent a quite wide color gamut in comparison with the BT. 709, and is increasingly adopted by many AV systems.

### CITATION LIST

### Patent Literature

### [PTL 1]

Japanese Unexamined Patent Application Publication No. 2006-33575

### SUMMARY OF INVENTION

### Technical Problem

Movies (cinemas) are contents actually having a wide color gamut and utilizing the wide color gamut. Silver halide films have been used for the cinemas over a long period of history. The silver halide films display color through subtractive color mixing, and thus have a different color gamut from that of the display devices. The silver halide films have a wide color gamut for dark color, and excel at representing mainly dark and vivid red (crimson) and so on. Although the cinemas have been gradually digitized, reproducing the color gamut is significant in expressing intention of producers, and thus projectors for screening digital cinema have adopted primaries having a wide color gamut for covering the silver halide films. Primaries widely used among the primaries are referred to as DCI (Digital Cinema Initiatives) minimum specification (hereinafter, referred to as DCI) which is a digital cinema specification.

A color gamut that can be represented according to the DCI is much wider than that of consumer televisions. However, the recent progress in display device has led the emergence of wide-color-gamut display devices which have primaries similar to those of the DCI and yet are for consumer use. There is a possibility that using such a display device allows faithful reproduction of color of digital cinema at home.

However, only the above xvYCC is available as a video format having a wide color gamut which can be used by the consumer display devices. Although the xvYCC allows the representation of the wide color gamut, the xvYCC cannot cover the entire color gamut of the DCI, and some of vivid colors cannot be represented. Thus, the color of the digital cinema cannot be directly reproduced at home.

FIG. 20 is a diagram in which a color gamut represented by the primaries of the DCI minimum specification is added to the diagram illustrating the conventional color representation shown in FIG. 19. DCI primaries 907 and 908 are the primaries of the DCI minimum specification, and the color gamut that can be represented according to the DCI is a parallelogram-shaped DCI color gamut 909 which is a range in which these primaries can be represented between 0 and 1 in logical value.

As represented in the diagram, in the DCI color gamut 909, there are colors out of an xvYCC region 903 (portions which represent most vivid color in the DCI color gamut 909, and are indicated by hatched lines) which is a range that can be represented according to the xvYCC. These colors cannot be represented according to the xvYCC, and thus cannot be represented on the conventional display devices. In practice, either these colors may be clipped or image reproduction in which clipping is not operated may be performed with emphasis on tone characteristics rather than color.

Here, newly standardizing a video format using, for instance, the DCI primaries 907 and 908 makes it possible to transmit the DCI color gamut 909. However, the video format for which primaries are changed has no backward compatibility with the conventional. BT. 709, and thus is not easily accepted by consumer markets. More specifically, when a video in which the DCI primaries 907 and 908 are used is displayed on the conventional display devices not corresponding to the DCI primaries 907 and 908, the video is displayed in dull color with low saturation, which makes realization of consumer apparatuses difficult.

In view of the above problems, the present invention has an object to provide a color signal converting apparatus, a video displaying apparatus, a color signal converting method, a video displaying method, and image data which correspond to the DCI color gamut and have backward compatibility with the xvYCC and the BT. 709.

### Solution to Problem

In order to achieve the above object, a color signal converting apparatus according to an aspect of the present invention is a color signal converting apparatus which performs conversion on a first color signal represented in a first color gamut, and which includes: a primary color conversion unit which converts the first color signal into a second color signal represented in a second color gamut which is wider than a predetermined color gamut defined by predetermined standard primary color points and which includes the predetermined standard primary color points; a gamma conversion unit which performs conversion on the second color signal according to a gamma characteristic; a luminance and chrominance conversion unit which converts, into a luminance signal and a chrominance signal, the second color signal converted by the gamma conversion unit; a chrominance signal conversion unit which converts, based on a conversion coefficient, the chrominance signal which is, within a possible value range of the chrominance signal, outside a value range that can be represented by the second color gamut, into a chrominance signal in a color gamut which is wider than the predetermined color gamut and narrower than the second color gamut; and an output unit which outputs, as an output signal, the chrominance signal converted by the chrominance signal conversion unit and the luminance signal converted by the luminance and chrominance conversion unit.

Here, the first color gamut is a color gamut of an image to be inputted, and is, for instance, a DCI color gamut or a color gamut wider than the DCI color gamut. In other words, the first color gamut is, for example, a color gamut having DCI primaries. Furthermore, the predetermined color gamut is, for instance, a BT. 709 color gamut, and the second color gamut is, for example, an xvYCC color gamut. To put it differently, with the above, the chrominance signal which is within the DCI color gamut or the color gamut wider than the DCI color gamut and which cannot be represented in the xvYCC color gamut is converted into the chrominance signal that can be represented in the xvYCC color gamut. Thus, the color signal converting apparatus performs conversion on only the chrominance signal without changing the luminance signal, and thus the color signal converting apparatus allows the chrominance signal to be represented in a color gamut corresponding to the DCI color gamut as well as in the xvYCC and the BT. 709.

Moreover, the chrominance signal conversion unit preferably performs the conversion on the chrominance signal by multiplying a value indicating chrominance of the chrominance signal by the conversion coefficient.

With this, the chrominance signal is converted by multiplying the chrominance by the conversion coefficient, and thus the chrominance signal can be converted into a chrominance signal having a continuous tone without clipping.

Furthermore, the chrominance signal conversion unit may perform conversion on each of a Cr signal and a Cb signal included in the chrominance signal, using a different conversion coefficient. Moreover, the chrominance signal conversion unit may perform conversion on each of a positive Cr signal and a negative Cr signal which are Cr signals, within a possible value range of the Cr signal, outside a positive value range and a negative value range of the Cr signal which are defined by the second color signal, using the different conversion coefficient. Further, the chrominance signal conversion unit may perform conversion on each of a positive Cb signal and a negative Cb signal which are Cb signals, within a possible value range of the Cb signal, outside a positive value range and a negative value range of the Cb signal which are defined by the second color signal, using the different conversion coefficient.

With this, each of the positive Cr signal, the negative Cr signal, the positive Cb signal, and the negative Cb signal can be converted using a corresponding one of the conversion coefficients according to the characteristics of the chrominance signal with respect to the positive Cr signal, the negative Cr signal, the positive Cb signal, and the negative Cb signal.

Furthermore, the chrominance signal conversion unit may perform the conversion on the chrominance signal based on a conversion coefficient set according to arbitrary two points between a first endpoint of a possible value range of the chrominance signal in the predetermined color gamut and a second endpoint of a possible value range of the chrominance signal in the second color gamut. Further, the chrominance signal conversion unit preferably performs the conversion on the chrominance signal based on a conversion coefficient set according to the first endpoint and the second endpoint.

With this, chrominance signals are converted into a line shape connecting the arbitrary two points between the first and second endpoints inclusive, and thus the conversion can be performed using simplified calculation.

Moreover, the color signal converting apparatus may further include: a color gamut determining unit which determines whether or not a color gamut is the first color gamut; and a control unit which decides the conversion coefficient based on a result of the determination by the color gamut determining unit, wherein the control unit may change the conversion coefficient according to a change in the first color gamut. In addition, the color signal converting apparatus may further include: a color gamut determining unit which determines whether or not a color gamut is the first color gamut; a control unit which determines whether or not to perform the conversion on the chrominance signal, based on a result of the determination by the color gamut determining unit; and an additional information generating unit which generates a flag which is information indicating whether or not the chrominance signal conversion unit has performed the conversion on the chrominance signal, wherein, in the case where the control unit determines to perform the conversion on the chrominance signal, the chrominance signal conversion unit may perform the conversion on the chrominance signal, and the additional information generating unit may generate the flag.

With this, the chrominance signal can be converted based on the decided conversion coefficient and the generated flag.

Moreover, the output unit may further output information indicating the conversion coefficient. Then, when the output signal is multiplexed with another information in a moving picture stream, the output unit may store the information indicating the conversion coefficient in a header of the moving picture stream, and output the stored information. Furthermore, in the case where the output signal is multiplexed with another information in a moving picture stream and the multiplexed output signal is written onto a recording medium, the output unit may store the information indicating the conversion coefficient in management information of the recording medium, and output the stored information. Moreover, in the case where the output signal is multiplexed with another information in a moving picture stream and the multiplexed output signal is transmitted to an external communication path, the output unit may output the information indicating the conversion coefficient through transmission using a protocol of the communication path.

With this, the conversion coefficient can be outputted by various methods.

Moreover, the output unit may further output a flag which is information indicating whether or not the chrominance signal conversion unit has performed the conversion on the chrominance signal. Then, when the output signal is multiplexed with another information in a moving picture stream, the output unit may store the flag in a header of the moving picture stream, and output the stored flag. Furthermore, in the case where the output signal is multiplexed with another information in a moving picture stream and the multiplexed output signal is written onto a recording medium, the output unit may store the flag in management information of the recording medium, and output the stored flag. Moreover, in the case where the output signal is multiplexed with another information in a moving picture stream and the multiplexed output signal is transmitted to an external communication path, the output unit may output the flag through transmission using a protocol of the communication path.

With this, the flag can be outputted by various methods.

Furthermore, in order to achieve the above object, a video displaying apparatus according to another aspect of the present invention is a video displaying apparatus which performs conversion on a luminance signal and a chrominance signal of a color signal and displays a video on a display device, and which includes: an input unit which receives a luminance signal and a chrominance signal; a color gamut expansion unit which expands, among received chrominance signals including the chrominance signal, a chrominance signal in a color gamut wider than a first color gamut and narrower than a second color gamut, at a predetermined ratio; an inverse luminance and chrominance conversion unit which converts the expanded chrominance signal and the received luminance signal into a color signal; an inverse gamma conversion unit which performs conversion on the color signal converted by the inverse luminance and chrominance conversion unit, according to an inverse gamma characteristic; a color signal conversion unit which converts the color signal converted by the inverse gamma conversion unit into a color signal which can be displayed on the display device; and a display unit which displays a video on the display device based on the color signal converted by the color signal conversion unit.

With this, the compressed chrominance signal can be expanded, and the video can be displayed on the display device. Here, the first color gamut is, for instance, the BT. 709 color gamut, and the second color gamut is the xvYCC color gamut. Stated differently, in the case where, for example, the chrominance signal which is, within the DCI color gamut, outside the BT. 709 color gamut is compressed into the chrominance signal having the color gamut that can be represented in the xvYCC, the video can be displayed on the display device which can represent the DCI color gamut by expanding the compressed chrominance signal into the signal having the DCI color gamut.

Moreover, the input unit may further receive a flag which is information indicating that the received chrominance signal has been converted, and the color gamut expansion unit may expand the chrominance signal in the color gamut wider than the first color gamut and narrower than the second color gamut, only in the case where the input unit receives the flag. In addition, the input unit may further receive information indicating a conversion coefficient showing the predetermined ratio, and the color gamut expansion unit may expand the chrominance signal based on the conversion coefficient.

With this, the chrominance signal can be expanded using the flag and the conversion coefficient received by the input unit.

Furthermore, the input unit may receive the flag stored in a header of a moving picture stream. Moreover, the input unit may receive the flag transmitted using a protocol of an external communication path.

With this, the flag can be received by various methods.

Furthermore, the color gamut expansion unit may expand each of a Cr signal and a Cb signal included in the received chrominance signal, using a different ratio. Moreover, the color gamut expansion unit may expand each of a positive Cr signal and a negative Cr signal which are Cr signals, within a possible value of the Cr signal, outside a value range of the first color gamut, using the different ratio. Further, the color gamut expansion unit may expand each of a positive Cb signal and a negative Cb signal which are Cb signals, within a possible value range of the Cb signal, outside a value range of the first color gamut, using the different ratio.

With this, each of the positive Cr signal, the negative Cr signal, the positive Cb signal, and the negative Cb signal can be expanded using a corresponding one of the ratios according to the characteristics of the chrominance signal with respect to the positive Cr signal, the negative Cr signal, the positive Cb signal, and the negative Cb signal.

Furthermore, the color gamut expansion unit may expand the chrominance signal up to a color gamut which can be displayed by the display device. Moreover, the video displaying apparatus may further include a color correction unit configured to correct a color gamut, wherein the color correction unit may perform color gamut correction in conformity with a color gamut of the display device after the color gamut expansion unit expands the chrominance signal.

With this, the color gamut expansion unit or the color correction unit expands and compresses the color gamut up to the color gamut which can be displayed by the display device, and thus the color gamut is corrected in conformity with the display device.

It is to be noted that the present invention can be realized not only as such color signal converting apparatus and video displaying apparatus but also as a method and a program having, as a step, each of processing units included in the color signal converting apparatus and the video displaying apparatus, a recording medium which stores the program, and an integrated circuit. In addition, the present invention can be realized as image data including, for instance, a chrominance signal, a luminance signal, information indicating a conversion coefficient, and a flag which are outputted by the color signal converting apparatus, and as a computer-readable recording medium which stores the image data.

### Advantageous Effects of Invention

The present invention provides (i) a color signal converting apparatus, (ii) a video displaying apparatus, (iii) a color signal converting method, and (iv) a video displaying method make it possible to faithfully process and record a significantly wide color gamut which has compatibility with BT. 709 in a BT. 709 color gamut range and substantial compatibility with xvYCC that is the expanded BT. 709 color gamut and which is further used for digital cinema, and to transmit recorded image data, and (v) the image data.

### BRIEF DESCRIPTION OF DRAWINGS

FIG. 1 is a block diagram showing a functional structure of a color signal converting apparatus according to Embodiment 1.

FIG. 2 is a flowchart showing an example of operations of the color signal converting apparatus according to Embodiment 1.

FIG. 3 is a diagram showing conversion characteristics of a gamma conversion unit.

FIG. 4 is a diagram showing a DCI color gamut on a chrominance plane.

FIG. 5 is a diagram illustrating conversion characteristics of a color gamut compressing unit according to Embodiment 1.

FIG. 6 is a diagram illustrating conversion characteristics of the color gamut compressing unit according to Embodiment 1.

FIG. 7A is a conceptual diagram schematically illustrating color gamut compression by the color gamut compressing unit according to Embodiment 1.

FIG. 7B is a conceptual diagram schematically illustrating color gamut compression by the color gamut compressing unit according to Embodiment 1.

FIG. 7C is a conceptual diagram schematically illustrating color gamut compression by the color gamut compressing unit according to Embodiment 1.

FIG. 8 is a specific block diagram showing an output unit according to Embodiment 1.

FIG. 9 is a specific block diagram showing the output unit according to Embodiment 1.

FIG. 10 is a diagram showing a schematic structure of MPEG2-TS.

FIG. 11 is a block diagram showing a functional structure of a video displaying apparatus according to Embodiment 2.

FIG. 12 is a specific block diagram showing an input unit according to Embodiment 2.

FIG. 13 is a specific block diagram showing the input unit according to Embodiment 2.

FIG. 14 is a flowchart showing an example of operations of the video displaying apparatus according to Embodiment 2.

FIG. 15 is a diagram illustrating conversion characteristics of an inverse gamma conversion unit.

FIG. 16 is a block diagram showing a functional structure of a video displaying apparatus according to Embodiment 3.

FIG. 17A is a diagram illustrating functions of the video displaying apparatus according to Embodiment 3.

FIG. 17B is a diagram illustrating functions of the video displaying apparatus according to Embodiment 3.

FIG. 18 is a diagram showing an example of image data for recording or transmitting a luminescence signal and a chrominance signal of a color signal.

FIG. 19 is a conceptual diagram illustrating color representation of a conventional video signal.

FIG. 20 is a conceptual diagram illustrating a DCI color gamut.

### DESCRIPTION OF EMBODIMENTS

The following describes a color signal converting apparatus and a video displaying apparatus according to the embodiments of the present invention with reference to the drawings.

### Embodiment 1

First, a color signal converting apparatus according to Embodiment 1 shall be described. The present embodiment is an embodiment relating to the color signal converting apparatus which records and transmits information having a wide color gamut in a luminance and chrominance format such as an xvYCC format. Actual application includes authoring which creates video discs or video signals from video cameras and wide color gamut materials, and so on.

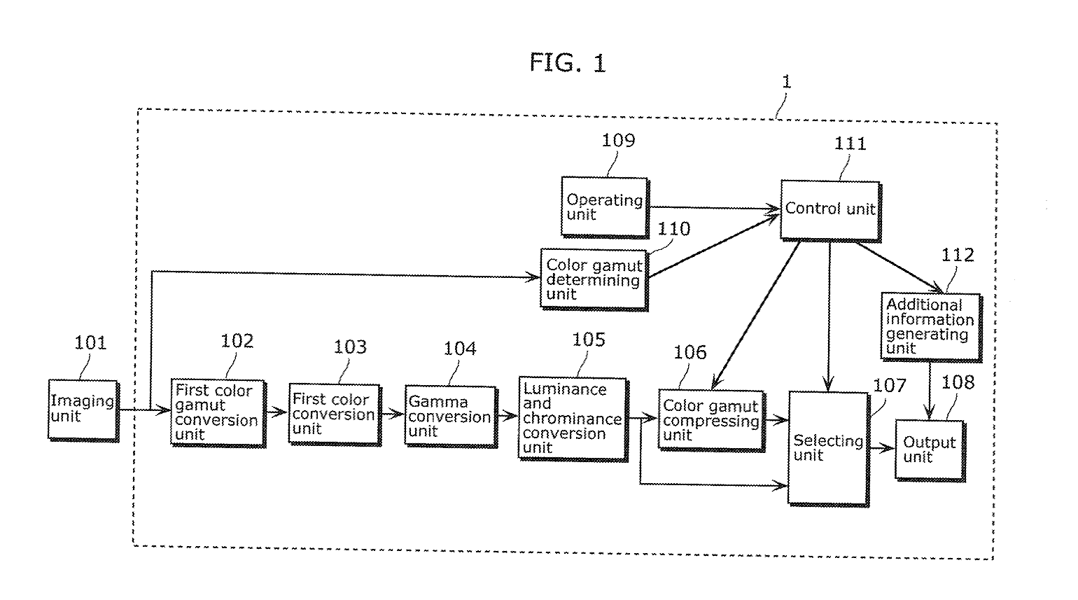

FIG. 1 is a block diagram showing a functional structure of the color signal converting apparatus according to Embodiment 1.

As shown in the block diagram, the color signal converting apparatus includes an imaging unit 101 and a first signal processing unit 1.

The imaging unit 101 has an optical system, an image sensor, and an A/D converter within, and is a part which is capable of imaging a desired object using a wide color gamut. Here, the imaging unit 101 images the desired object using a color gamut wider than a DCI color gamut.

The first signal processing unit 1 is a processing unit which outputs a scene imaged by the imaging unit 101 as a luminescence and chrominance signal which has BT. 709 primaries and can be represented using an xvYCC color gamut. As shown in the block diagram, the first signal processing unit 1 includes: a first color gamut conversion unit 102; a first color conversion unit 103; a gamma conversion unit 104; a luminance and chrominance conversion unit 105; a color gamut compressing unit 106; a selecting unit 107; an output unit 108; an operating unit 109; a color gamut determining unit 110; a control unit 111; and an additional information generating unit 112.

The first color gamut conversion unit 102 and the first color conversion unit 103 convert a first color signal into a second color signal represented in a second color gamut which is wider than a predetermined color gamut defined by predetermined standard primary color points and has the predetermined standard primary color points. Here, the first color signal is a color signal represented in the DCI color gamut or the color gamut wider than the DCI color gamut. Furthermore, the predetermined primary color points are, for example, the primaries defined in the BT. 709 standard. Moreover, the second color gamut is a color gamut which is wider than the BT. 709 color gamut and has the BT. 709 primaries. Here, the second color gamut is a color gamut represented according to the xvYCC.

More specifically, the first color gamut conversion unit 102 converts a color gamut of a color signal obtained through the imaging of the imaging unit 101 into a color gamut which has the DCI primaries and is within the DCI color gamut.

Moreover, the first color conversion unit 103 converts, into the BT. 709 primaries, the DCI primaries of the color signal outputted from the first color gamut conversion unit 102.

Here, a “primary color conversion unit” in Claims may have the same functions as the first color conversion unit 103 or the same functions as the first color conversion unit 103 and the first color gamut conversion unit 102.

The gamma conversion unit 104 performs conversion on the second color signal according to a gamma characteristic. More specifically, the gamma conversion unit 104 performs conversion through gamma correction defined in the xvYCC so that a color signal inputted with a negative value and a value above 1 can be processed.

The luminance and chrominance conversion unit 105 converts the second color signal into a luminance signal and a chrominance signal. More specifically, the luminance and chrominance conversion unit 105 converts an R, G, and B color signal converted through gamma correction into a luminance signal and a chrominance signal.

The color gamut compressing unit 106 converts, based on a conversion coefficient, the chrominance signal which is, within a possible value range of the chrominance signal, outside of a value range that can be represented by the second color gamut, into a chrominance signal having a color gamut which is wider than the predetermined color gamut and narrower than the second color gamut. Here, the second color gamut is a color gamut which can be represented according to the xvYCC. More specifically, the color gamut compressing unit 106 compresses a color gamut exceeding a signal range defined in the xvYCC into a value range of the chrominance signal defined in the xvYCC. Here, a “chrominance signal conversion unit” in Claims has the same functions as the color gamut compressing unit 106.

The selecting unit 107 determines whether or not the color gamut compressing unit 106 is to compress the color gamut.

The output unit 108 outputs an output signal of the selecting unit 107. More specifically, the output unit 108 outputs, as the output signal, the chrominance signal converted by the color gamut compressing unit 106 and the luminance signal converted by the luminance and chrominance conversion unit 105. Furthermore, the output unit 108 outputs a flag which is information indicating a conversion coefficient or information indicating whether or not the color gamut compressing unit 106 has performed conversion on the chrominance signal.

The operating unit 109 conveys, to the control unit 111, intentions of an operator through a user I/F.

The color gamut determining unit 110 checks a color distribution of the entire scene including the object imaged by the imaging unit 101, and determines a color gamut of the imaged scene.

The control unit 111 controls operations of the whole color signal converting apparatus according to the present embodiment. For instance, the control unit 111 decides the conversion coefficient based on the result determined by the color gamut determining unit 110, and changes the conversion coefficient according to the result. In addition, the control unit 111 determines whether or the chrominance signal is to be converted based on the result determined by the color gamut determining unit 110.

The additional information generating unit 112 generates information added to a video signal, according to an instruction from the control unit 111. For example, the additional information generating unit 112 generates a flag which is information indicating whether or not the color gamut compressing unit 106 has performed conversion on the chrominance signal.

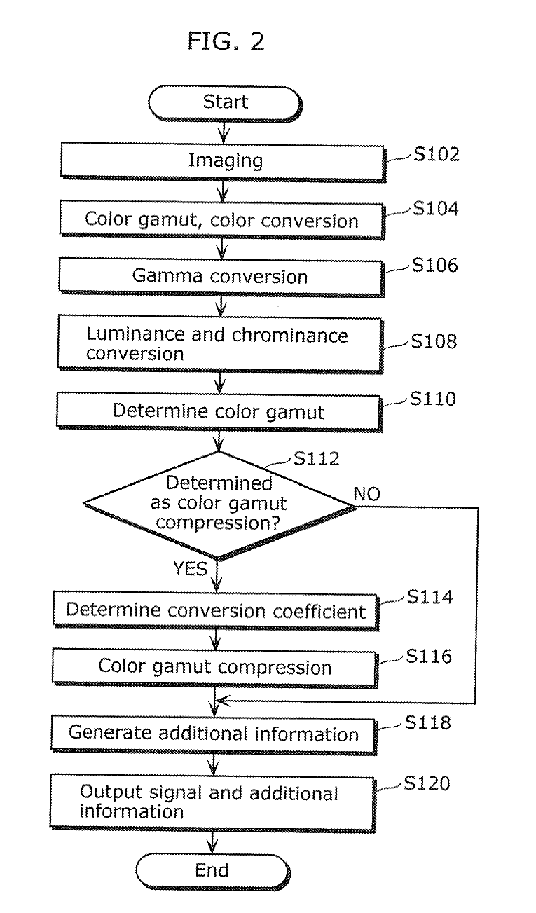

FIG. 2 is a flowchart showing an example of operations of the color signal converting apparatus according to Embodiment 1.

First, the imaging unit 101 generates a color signal having a color gamut wider than a DCI color gamut by imaging a desired object (S102).

Then, the first color gamut conversion unit 102 converts the color gamut of the color signal generated by the imaging unit 101 into a color gamut which is within the DCI color gamut, and further the first color conversion unit 103 converts DCI primaries into BT. 709 primaries (S104).

Next, the gamma conversion unit 104 performs gamma correction on the color signal generated by the first color conversion unit 103, according to a gamma characteristic (S106).

Then, the luminance and chrominance conversion unit 105 converts R, G, and B primaries obtained through the gamma correction into a luminance signal and a chrominance signal (S108).

Then, the color gamut determining unit 110 determines a color gamut of an entire scene including the object imaged by the imaging unit 101 (S110).

Then, the control unit 111 determines whether or not the color gamut is to be compressed, based on the result determined by the color gamut determining unit 110 (S112).

When it is determined that the color gamut is to be compressed (Yes in S112), the control unit 111 decides a conversion coefficient for the color gamut compression based on the result determined by the color gamut determining unit 110 (S114).

Then, the color gamut compressing unit 106 compresses a color signal exceeding a signal range defined in xvYCC into a value range of a color signal defined in the xvYCC, based on the conversion coefficient (S116).

More specifically, the color gamut compressing unit 106 performs conversion on the chrominance signal using the conversion coefficient. Furthermore, the color gamut compressing unit 106 performs conversion on each of a Cr signal and a Cb signal which are included in the chrominance signal to be compressed, using a different conversion coefficient. Moreover, the color gamut compressing unit 106 performs conversion on each of a positive Cr signal and a negative Cr signal which are Cr signals, within a possible value range of the Cr signal, outside a positive value range and a negative value range of a Cr signal which are defined in the BT. 709, using a different conversion coefficient. Furthermore, the color gamut compressing unit 106 performs conversion on each of a positive Cb signal and a negative Cb signal which are Cb signals, within a possible value range of the Cb signal, outside a positive value range and a negative value range of a Cb signal which are defined in the BT. 709, using a different conversion coefficient.

Further, the color gamut compressing unit 106 performs conversion on the chrominance signal based on a conversion coefficient set according to arbitrary two points between a first endpoint of a possible value range of the chrominance signal which is defined in the BT. 709 standard and a second endpoint of a possible value range of the chrominance signal which is defined in the xvYCC inclusive. The arbitrary two points are, for instance, the first and second endpoints. The details are described later.

Next, the additional information generating unit 112 generates additional information such as a flag indicating that the color gamut compressing unit 106 has performed the color gamut compression (S118).

Moreover, when the control unit 111 determines that the color gamut compression is not to be performed (No in S112), the selecting unit 107 determines that the color gamut compressing unit 106 is not to compress the color gamut, and the additional information generating unit 112 generates additional information which is a flag indicating that the color gamut compressing unit 106 has not performed the color gamut compression (S118).

Then, the output unit 108 outputs an output signal, information indicating the conversion coefficient, the flag indicating whether or not the color gamut compressing unit 106 has compressed the color gamut, and so on (S120).

The following describes an example of specific operations according to the present embodiment. Here, the description is given assuming that the imaging unit 101 is a digital video camera which can perform imaging using a color gamut which is similar to or exceeds the DCI color gamut.

The first color gamut conversion unit 102 limits, in a visually natural manner, an output signal to a signal within a range of the DCI color gamut through well-known color gamut conversion processing when there is a color region exceeding the DCI color gamut, the output signal being obtained through the imaging by the imaging unit 101 and represented by the primaries (R, G, and B) determined by a color filter of an image sensor of the camera. It is to be noted that a color gamut conversion technique may be any technique which can limit a color gamut such as gamut conversion processing (Non Patent Literature: “Fundamentals of Color Engineering”, Corona Publishing Co., Ltd., pp. 178-180).

Furthermore, when the imaging unit 101 cannot perform imaging using the color gamut exceeding the DCI color gamut, the first color gamut conversion unit 102 is unnecessary. Moreover, apart from some of illuminants, very few objects have the color gamut exceeding the DCI color gamut, and thus omitting the first color gamut conversion unit 102 has a small impact.

Next, the first color conversion unit 103 converts the color signal limited to the DCI color gamut into the primaries defined in the BT. 709 standard. A linear matrix exemplified below is normally used for the conversion. A matrix coefficient can be uniquely determined when chromaticity values of a chromaticity point of each of input primaries and output primaries and an input and output white point at a time of converting primaries determined by a spectral distribution of the filter of the imaging unit 101 into the BT. 709 primaries are set. In many cases, other correction components such as a white balance coefficient are included in the matrix coefficient and often collectively processed in an actual embodied structure, and thus a coefficient is not necessarily determined in the manner described above. Here, for the sake of simplicity of description, a case where wider portions of primaries of the imaging unit 101 just match the DCI primaries is described as an example. In this case, the first color gamut conversion unit 102 is obviously unnecessary.

$$( \begin{matrix}{R}_{709} \\ {G}_{709} \\ {B}_{709}\end{matrix} ) = ( \begin{matrix}1.120713 & - 0.234649 & 0.000000 \\ - 0.038478 & 1.087034 & 0.000000 \\ - 0.017967 & - 0.08203 & 0.954576\end{matrix} ) ( \begin{matrix}R \\ G \\ B\end{matrix} ) \qquad [ Math . 1 ]$$

A wide color gamut defined in the DCI is represented by primaries indicating a relatively narrow color gamut such as the BT. 709, and thus the matrix of the first color conversion unit 103 has a coefficient which increases a difference in values of R, G, and B. Even when a value in the range of 0 to 1 is given to R, G, and B, R₇₀₉, G₇₀₉, and B₇₀₉ to be outputted take a negative value or a value above 1. For instance, when each of R, G, and B, the DCI primaries, falls within the range of 0 to 1, R₇₀₉, G₇₀₉, and B₇₀₉ of the BT. 709 after color conversion take a value between −0.235 and 1.121, a value between −0.039 and 1.087, and a value between −0.100 and 0.955, respectively.

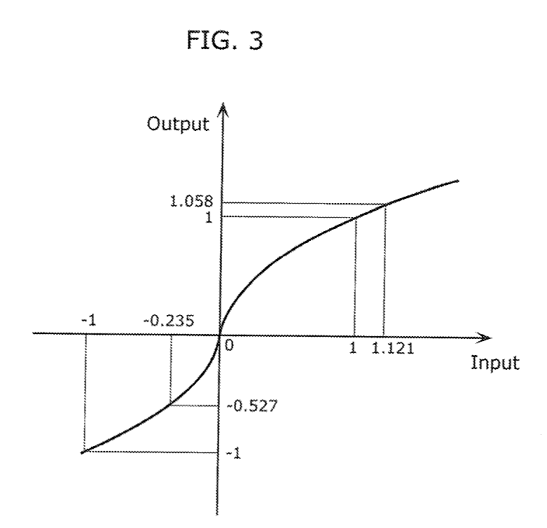

Hence, the gamma conversion unit 104 needs to perform conversion on R₇₀₉, G₇₀₉, and B₇₀₉ in the above ranges. FIG. 3 is a diagram showing conversion characteristics of R₇₀₉, G₇₀₉, and B₇₀₉, and the diagram is formed according to the equations below. The same conversion is performed on R₇₀₉, G₇₀₉, and B₇₀₉, and thus only R₇₀₉ is described here. In other words, the equations below are calculation equations which calculate output values of input R₇₀₉. Moreover, R in the range of 0 to 1 can be defined by the BT. 709. As stated above, possible value ranges of R₇₀₉, G₇₀₉, and B₇₀₉ differ from each other, and thus it is only necessary to provide a circuit or a table which can process only a necessary range.

R₇₀₉^{©}=1.099·(R₇₀₉)^{0.45}−0.099 0.018≦R₇₀₉

R₇₀₉^{©}=4.5·R₇₀₉ −0.018≦R₇₀₉<0.018

R₇₀₉^{©}=−(1.099·(−R₇₀₉)^{0.45}−0.099) R₇₀₉<−0.018 [Math. 2]

The luminance and chrominance conversion unit 105 converts the gamma-converted BT. 709 primaries into a luminance signal and a chrominance signal defined in the BT. 709. The conversion characteristics are expressed by the following equation.

$$( \begin{matrix}{Y}_{709}^{′} \\ {Cb}_{709}^{′} \\ {Cr}_{709}^{′}\end{matrix} ) = ( \begin{matrix}0.2126 & 0.7152 & 0.0722 \\ - 0.1146 & - 0.3854 & 0.5000 \\ 0.5000 & - 0.4542 & - 0.0458\end{matrix} ) ( \begin{matrix}{R}_{709}^{′} \\ {G}_{709}^{′} \\ {B}_{709}^{′}\end{matrix} ) \qquad [ Math . 3 ]$$

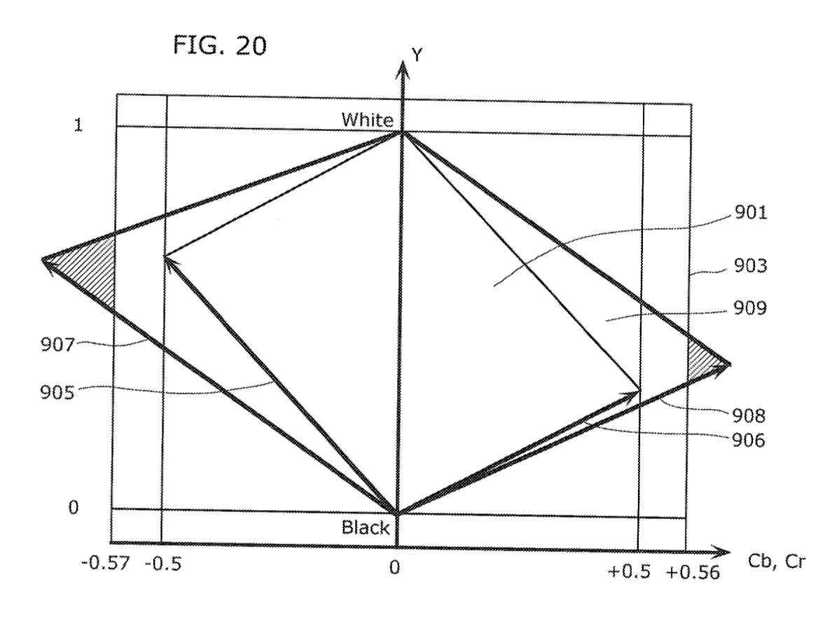

Furthermore, the conversion causes the DCI color gamut (the DCI color gamut 909 shown in FIG. 20) to include color gamuts (shaded areas in FIG. 20) that do not fall within the range of −0.57 to 0.56 which is a range that the luminance signal and the chrominance signal defined in the xvYCC can represent with 8 bits. The color gamuts are clipped according to the conventional xvYCC.

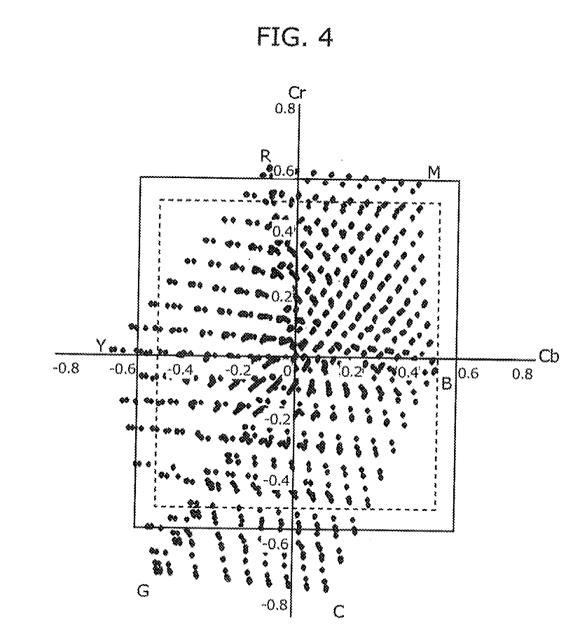

FIG. 4 is a diagram showing the DCI color gamut on a chrominance plane, and the diagram is a Cb-Cr plane which is created by mapping colors (11×11×11=1331 colors) that are evenly distributed over the entire DCI color gamut to ranges of the Cb signal and the Cr signal defined in the xvYCC and excluding luminance information, and which is viewed from above. A solid square in the diagram indicates that each of the Cb signal and the Cr signal falls within the range of −0.57 to 0.56, and colors within the square can be represented according to the xvYCC. Similarly, a dashed square indicates a value range that can be represented by the chrominance signal of which the Cb signal and the Cr signal are in the range of ±0.5 and which is according to the BT. 709 standard.

In comparison with the chrominance signal according to the BT. 709 standard, the chrominance signal according to the xvYCC has been reformed so that a possible value range of the same is expanded, but the chrominance signal according to the xvYCC cannot represent an entire possible value range of a chrominance signal of the DCI color gamut having a wide color gamut. Moreover, a degree of exceeding the value range that can be represented according to the xvYCC is not uniform in the DCI color gamut, and differs from color to color. For example, green (G), cyan (C), and yellow (Y) significantly exceed the value range, and red (R) also slightly exceeds the value range. However, the degree of exceeding on the Cb-Cr plane does not directly match a difference in color viewed with eyes. A difference in red color slightly exceeding the value range is large.

Then, the color gamut compressing unit 106 compresses, into a color gamut that can be represented according to the xvYCC, the luminance signal and the chrominance signal converted from the BT. 709 primaries having a color gamut exceeding the xvYCC color gamut. The color gamut compression is a kind of color gamut conversion, and may include various techniques. Usual color gamut conversion sets a goal of natural image quality, and often involves non-linear complex conversion. However, the color gamut compression according to the present embodiment is color gamut compression for which it is insufficient that an image obtained by performing color gamut compression only has superior image quality and it is assumed that the compressed color gamut is inversely converted into an original color gamut, and thus performing accurate conversion with limited bit precision is a top priority issue. As a matter of course, in order to obtain substantial backward compatibility with the xvYCC, image quality needs to be superior in a situation where inverse conversion is not performed on a color gamut, that is, in a situation where the normal color gamut conversion is performed on the color gamut.

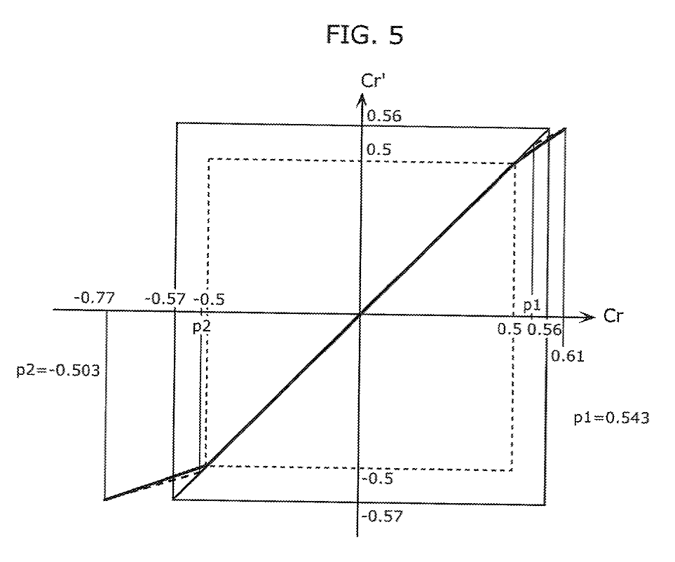

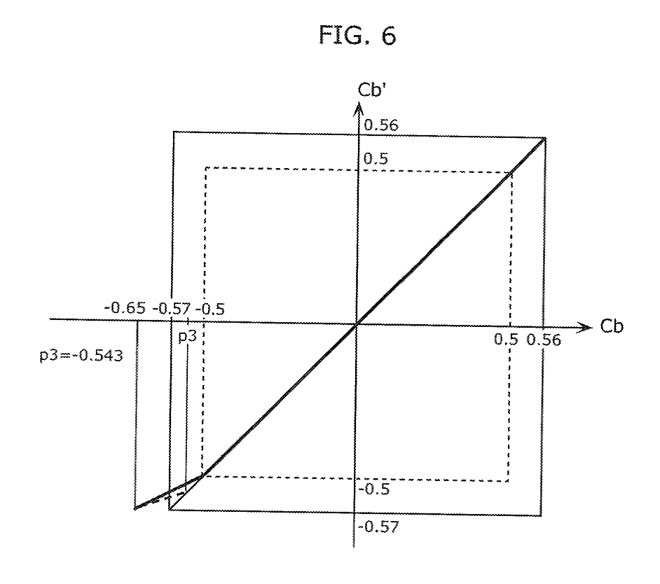

In the present invention, a distribution in the DCI color gamut as shown in FIG. 4 and the like is examined in detail, and a color gamut compression method as indicated below is obtained. Each of FIGS. 5 and 6 is a diagram illustrating an example of conversion characteristics of the color gamut compressing unit 106 according to the present embodiment. In FIG. 5, the horizontal axis indicates a Cr signal that is one of chrominance signals inputted to the color gamut compressing unit 106, and the vertical axis indicates a Cr signal after color gamut compression (Cr′). Likewise, in FIG. 6, the horizontal axis indicates a Cb signal that is one of chrominance signals inputted to the color gamut compressing unit 106, and the vertical axis indicates a Cb signal after color gamut compression (Cb′).

A basic idea of the color gamut compression is that the DCI color gamut converts a value range requested from each of the Cb signal and the Cr signal into a value range accepted for each of the Cb signal and the Cr signal requested by the xvYCC color gamut, using independent broken line conversion with respect to each of the Cb axis and the Cr axis. FIG. 5 shows the conversion characteristics of the Cr signal in the chrominance signal. Conversion which compresses the range of 0.5 to 0.61 into the range of 0.5 to 0.56 is performed for a positive Cr signal (conversion characteristics indicated by solid lines). Conversion which compresses the range of −0.77 to −0.5 into the range of −0.57 to −0.5 is performed for a negative Cr signal. Conversion which compresses the range of −0.65 to −0.5 into the range of −0.57 to −0.5 is performed for the negative Cb signal (conversion characteristics indicated by solid lines).

The present color gamut compression method is obtained from the following considerations.

The first condition is ensuring complete backward compatibility with the BT. 709 standard, the goal of the present invention. Thus, it is necessary not to cause the chrominance signal to change the value range (within the dashed square shown in FIG. 4) that can be represented in the chrominance plane according to the BT. 709 standard, without changing luminance.

The second condition is ensuring substantial backward compatibility with the xvYCC, another goal of the present invention. The substantial compatibility with the xvYCC means that when conventional xvYCC-enabled apparatuses that do not perform color gamut expansion on a color signal (i) on which the color gamut compression of the present invention is performed and (ii) which is represented according to the xvYCC perform display, image degradation is absent or too little to be ignored in comparison with the time when the color gamut compression of the present invention is not performed. This means that the color gamut compression of the present invention needs to be the color gamut conversion which allows good image quality. Accordingly, change of brightness and hue which have a high visual sensitivity and are easily noticeable for change is kept to the minimum, and saturation compression which is not easily noticeable for change is mainly performed. In addition, color gamut compression is performed through continuous saturation compression so that gradation is not saturated.

The third condition is ensuring tone characteristics. The color gamut compression is the expansion of the xvYCC and performed with the limited bit precision of 8 bits, and thus the color gamut compression method needs to cause little deterioration in tone characteristics. A color gamut is expanded to obtain high image quality, and thus it is pointless if the tone characteristics are deteriorated even when the color gamut is expanded. Every time signals having the precision of only 8 bits are converted into various color spaces or are nonlinearly compressed, the bit precision is reduced. In addition, when the signals on which nonlinear conversion is performed are inversely converted, the precision changes for each tone. Accordingly, a tone having bad tone characteristics occur in principle. Thus, it is preferable to convert the Cb signal and the Cr signal into signals in a color space that is as simple as possible, and compression characteristics are preferably linear compression. In addition, it is essential that processing is simple.

The color gamut compression method which is shown in FIG. 5 and FIG. 6 is employed in the present embodiment as a method satisfying the above conditions. Generally, in order to suppress easily-noticeable hue change, a compression method in which a two-dimensional process reduces a distance from the origin so that a hue angle is not changed with a chrominance plane being polar coordinates is employed as the saturation compression. Although such a method can be employed even in the present embodiment, in view of characteristics of coordinates of a color to be compressed, a method in which a one-dimensional process prioritizes ensuring of precision in compression and expansion is performed. FIG. 5 shows tone conversion (inputting Cr, and outputting Cr′) of a Cr signal through an independently performed one-dimensional process, and FIG. 6 shows tone conversion of Cb through a one-dimensional process. The color gamut compression is performed by simultaneously performing the tone conversion through these two one-dimensional processes.

Each of the Cb signal and the Cr signal does not change the range of −0.5 to 0.5, and thus it is obvious that the color gamut compression satisfies the first condition.

Moreover, color signals exceeding a value range that can be represented according to the xvYCC are R, Y, G, and C. However, R and C are roughly parallel to the Cr axis and Y is roughly parallel to the Cb axis, and thus even when one-dimensional compression is performed along each of the Cr axis and the Cb axis, saturation change mainly occurs and little hue change occurs. Remaining G is covered roughly at the same time by negative compression along the Cr axis and negative compression along the Cb axis, and thus the hue change is still suppressed and the saturation change mainly occurs. Accordingly, continuous saturation compression is performed on the color signals exceeding the value range that can be represented according to the xvYCC. Thus, the continuous saturation compression excels in image quality when the color gamut conversion is performed, and the second condition is also satisfied.

Furthermore, the tone degradation is kept to the minimum because the tone conversion is conversion for changing a slope of a straight line, and thus the third condition is also satisfied. For example, when a range is compressed with the slope of ½ and expanded by doubling the slope, tone accuracy of the compressed range is reduced by ½, that is, 1 bit. When the range compression is performed using a nonlinear curve, there are tones having a compression rate lower than ½ but there are also tones having a compression rate greater than ½, and tone accuracy of specific tones is significantly deteriorated.

On the other hand, reduction in accuracy of specific tones does not occur in linear compression using a broken line.

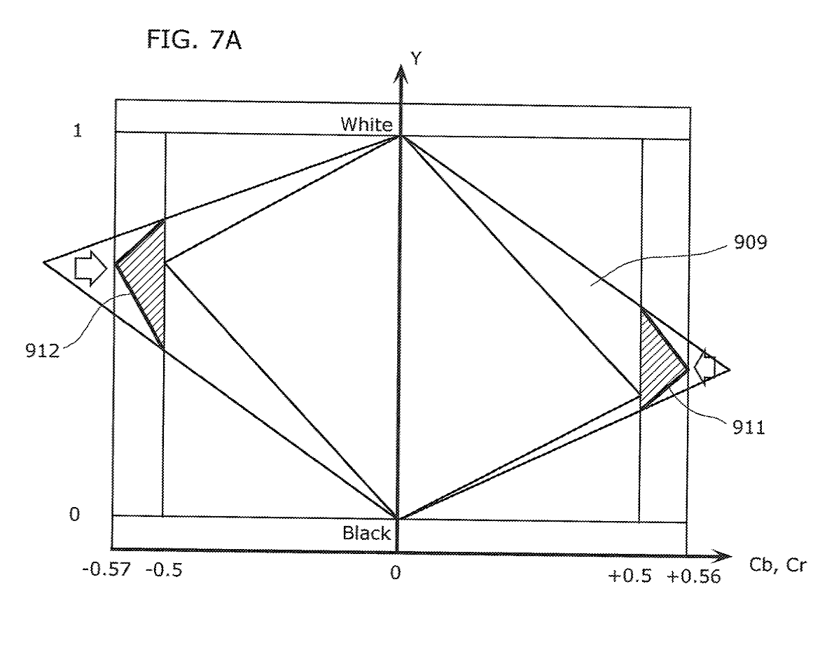

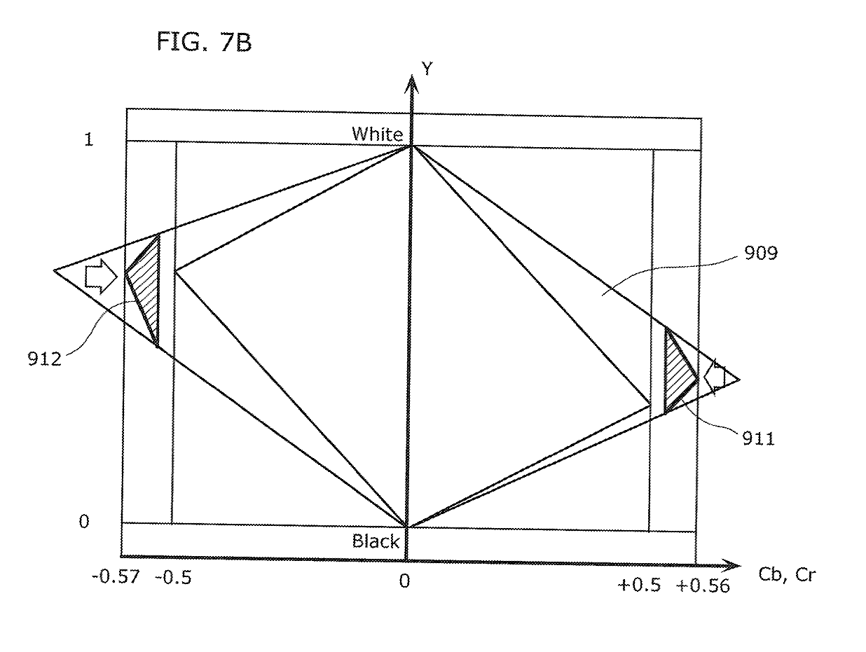

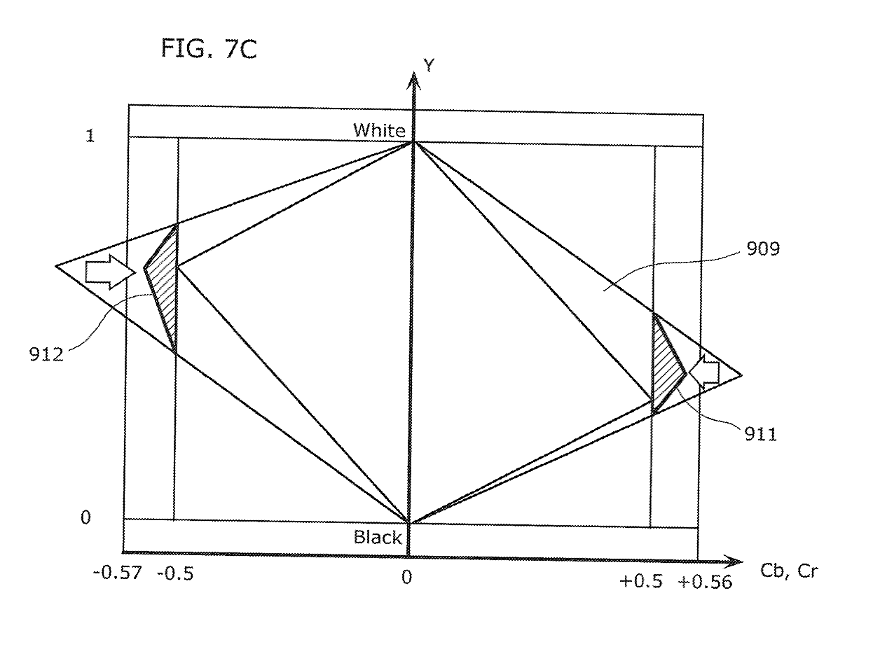

FIG. 7A is a conceptual diagram schematically illustrating color gamut compression by the color gamut compressing unit 106 according to the present embodiment.

As shown in the diagram, the color gamut compressing unit 106 performs color gamut compression on the DCI color gamut 909. More specifically, a region in which the chrominance of the DCI color gamut 909 indicates a value above 0.5 and a region in which the chrominance of the DCI color gamut 909 indicates a value below −0.5 are compressed into shaded regions 911 and 912 shown in the diagram. With this, the shaded areas of the DCI color gamut 909 shown in FIG. 20 can be compressed within the shaded regions 911 and 912.

(Modification of Color Gamut Compressing Unit)

Each of FIG. 7B and FIG. 7C is a conceptual diagram schematically illustrating color gamut compression by the color gamut compressing unit 106 according to a modification of the present embodiment.

As shown in these diagrams, the color gamut compressing unit 106 performs color gamut compression on the DCI color gamut 909. More specifically, as shown in FIG. 7B, a region in which the chrominance of the DCI color gamut 909 indicates a value above 0.5 and a region in which the chrominance of the DCI color gamut 909 indicates a value below −0.5 are compressed into the shaded region 911 which indicates a value below 0.56 and the shaded region 912 which indicates a value above −0.57, respectively. Moreover, as shown in FIG. 7C, a region in which the chrominance of the DCI color gamut 909 indicates a value above 0.5 and a region in which the chrominance of the DCI color gamut 909 indicates a value below −0.5 are compressed into the shaded region 911 which indicates a value below 0.56 and the shaded region 912 which indicates a value above −0.57, respectively.

With this, the shaded areas of the DCI color gamut 909 shown in FIG. 20 can be compressed within the shaded regions 911 and 912.

Further, more specifically, compression characteristics indicated by dashed lines in FIG. 5 and FIG. 6 are described as the modification of the color gamut compressing unit 106. FIG. 5 shows the compression characteristics of the Cr signal, and FIG. 6 shows the compression characteristics of the Cb signal.

The color gamut compressing unit 106 performs compression on a region indicating a chrominance value below 0.61 with the slope of ¼, for the positive Cr signal. The lower limit of a compression range is up to an intersection point (p1) with a straight line from the origin having the slope of 1. The color gamut compressing unit 106 performs compression on a region indicating a chrominance value below −0.77 with the slope of ¼, for the negative Cr signal. The upper limit of the compression range is up to an intersection point (p2) with the straight line from the origin having the slope of 1. In this case, p1=0.543 and p2=−0.503, and thus the range of −0.5 to 0.5 is not changed.

Furthermore, the color gamut compressing unit 106 performs compression on a region indicating a chrominance value above −0.65 with the slope of ¼, for the negative Cb signal. Here, an intersection point p3 indicates −0.543, and a point that the compression does not affect the range of −0.5 to 0.5 is the same as the above-mentioned characteristics indicated by the solid lines. The slope with which the compression conversion is performed is fixed to ¼ that is divisible by 2 in the present modification, and thus it is possible to most properly maintain the precision in the compression and expansion.

In this case, the color gamut compression by the color gamut compressing unit 106 is illustrated by the diagram as shown in FIG. 7B. It is to be noted that the slope of ¼ may be ½ for the positive Cr signal.

It is to be noted that although the compression is performed with the slope of ¼ with reference to the maximum and minimum Cb signals and Cr signals in the present modification, the compression may be performed with the slope of ¼ with reference to a Cb signal and a Cr signal that indicate 0.5. In this case, the color gamut compression by the color gamut compressing unit 106 is illustrated by the diagram as shown in FIG. 7C.

As stated above, compressed ranges are specified from a total of four points that are (i) endpoints of the positive and negative values in the possible value range of the Cr signal and (ii) endpoints of the positive and negative values in the possible value range of the Cb signal, and thus a conversion coefficient for compression is calculated based on the values of the four points.

It is to be noted that the positive compressed range and the negative compressed range of the Cr signal and the Cb signal are not limited by the conversion coefficient, and the same holds true for any conversion coefficient as long as the conversion coefficient produces a substantively equivalent effect. For example, a range can be slightly different, the Cb signal and the Cr signal or the positive compressed range and the negative compressed range can be identical with each other, and the like. Moreover, although it is stated that the range of ±0.5 of the Cb signal and the Cr signal is not changed, even including a value slightly off the range of ±0.5 such as 0.48 within the range of ±0.5 does not make the compatibility with the BT. 709 a problem.

It is to be noted that although the color gamut compressing unit 106 performs the one-dimensional compression on each of the Cb signal and the Cr signal in the present embodiment, performing two-dimensional compression on the Cb-Cr plane enables color gamut compression towards the origin along each of hues of R, G, B, C, M, and Y shown in FIG. 4 and keeps the hue change to the minimum. Thus, it is possible to further increase the compatibility with the xvYCC.

Furthermore, the selecting unit 107 determines whether or not the color gamut compressing unit 106 is to perform the processing, and an instruction from the control unit 111 allows the color gamut compressing unit 106 to set the above-mentioned color gamut compression method, a compression range, and a compression parameter.

The control unit 111 determines whether or not a color gamut processing is to be compressed, depending on a shooting mode (e.g., a landscape shooting mode, a figure shooting mode, a flower shooting mode, a baby shooting mode, a night scene shooting mode, and a fireworks shooting mode) indicated by a user with the operating unit 109, a type of image reproduction (faithful, colorful, sepia, and so on), or a color gamut of an object being shot which is determined by the color gamut determining unit 110 (whether or not there are many vivid colors, and whether or not there is any color exceeding the xvYCC color gamut). If it is determined that the color gamut compression processing is to be performed, the control unit 111 determines which parameter is to be used, and gives an instruction to the color gamut compressing unit 106 or the selecting unit 107.

The color gamut determining unit 110 extracts, from a shot image of the imaging unit 101, some vivid colors in a scene being shot, and estimates a color gamut of the shot scene based on these colors. An object having vivid colors which influence decision of the color gamut does not necessarily exist in each scene. Accordingly, when there is no color signal exceeding the value range that can be represented according to the xvYCC, the maximum color gamut is the xvYCC color gamut, and when a color signal exceeding the color gamut defined in the xvYCC is extracted, a color gamut including at least a color indicated by the color signal is estimated to be the maximum color gamut.

To put it differently, the control unit 111 determines whether or not to cause the color gamut compressing unit 106 to compress a color gamut, starting from the maximum color gamut estimated by the color gamut determining unit 110. In addition, the control unit 111 may decide a parameter of the color gamut compressing unit 106 so that the parameter works with a range which is determined from the maximum color gamut and into which the maximum color gamut is compressed.

Moreover, the color gamut compressing unit 106 can perform only compression in a specific color axis direction such as only the positive value or only the negative value of the Cr signal, or only the positive value or only the negative value of the Cb signal, depending on color signals of an object which exceed the value range that can be represented according to the xvYCC. Furthermore, from the point of view of color continuity, it is preferable for image quality that a compression parameter in the case of video shooting is changed slowly in terms of time. For instance, it takes few seconds for the overall change. Moreover, instead of slowing down the change of the compression parameter, change of the detected maximum color gamut may be slowed down.

Further, the control unit 111 gives an instruction to the additional information generating unit 112 to generate metadata regarding the parameter which is used in determining whether or not the above color gamut is to be compressed and which is used for the color gamut compression, and causes the output unit 108 to output the metadata.

The output unit 108 outputs the metadata and video data as a set.

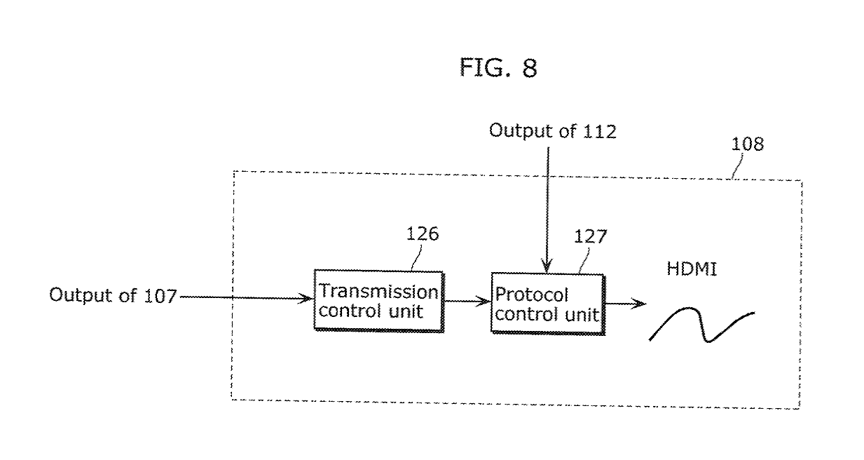

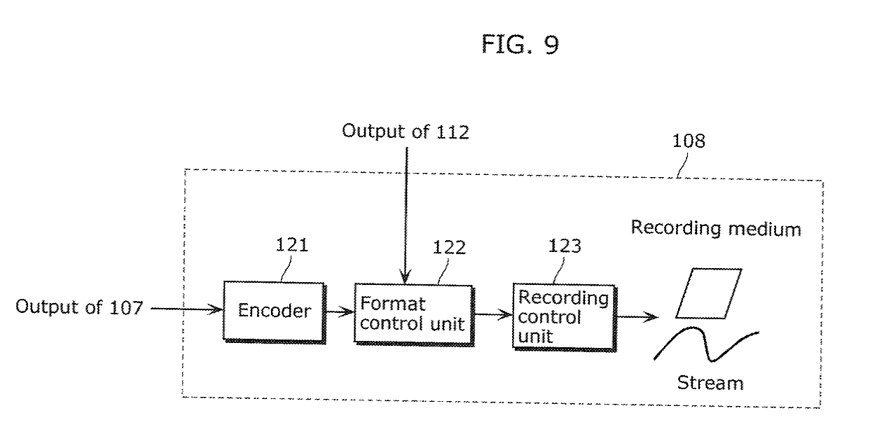

Each of FIG. 8 and FIG. 9 is a specific structure diagram of the output unit 108.

FIG. 8 shows the output unit 108 in a form of an interface such as HDMI which transmits uncompressed video data without using a codec such as MPEG-2 and H.264.

A transmission control unit 126 is a processing unit which controls transmission of uncompressed video data, and a protocol control unit 127 is a processing unit which controls interface protocols.

An uncompressed interface is used for the output unit 108, and generally such an interface cannot often add metadata to video data. Taking HDMI as an example, the metadata cannot be added to the video data. However, such data can be exchanged with a reception side by using the protocols before transmission. The protocol control unit 127 transmits information indicating whether or not the color gamut has been compressed and the color gamut compression parameter through protocols with a reception device, and subsequently transmits uncompressed video data.

Furthermore, commands may be newly defined using HDMI-CEC (Consumer Electronics Control), and the information indicating whether or not the color gamut has been compressed and the color gamut compression parameter may be transmitted. It is to be noted that the transmission may be performed using existing commands.

FIG. 9 shows the output unit 108 which compresses video data using a codec such as MPEG-2 and H.264, and outputs the compressed video data.

An encoder 121 is an encoder which compresses a data amount of video data, using publicly known algorithm. A format control unit 122 builds, for instance, standardized file formats or stream formats, using the video data compressed by the encoder 121. A recording control unit 123 records the files or streams in a storage medium such as a tape, a hard disk, a memory, and a memory card.

When the color gamut compressing unit 106 performs the color gamut compression on video data, the encoder 121 performs data amount compression on the video data, the format control unit 122 adds, to the video data, metadata such as a flag indicating that the color gamut compression has been performed, and the recording control unit 123 writes the video data onto the recording medium. When the color gamut compression is not performed, a flag indicating that the color gamut compression has not been performed is added or a flag itself regarding the color gamut compression is not added.

The format control unit 122 operates in the same manner not only in format creation as file but also in format creation as stream.

It is to be noted that when the color gamut compression is performed, not only the flag indicating that the color gamut compression has been performed but also the color gamut compression parameter itself may be added. The compression parameter may be defined by the actual compression characteristics such as coordinates or slope of a broken line, predefined codes indicating compression characteristics, a percentage of a compression range or a degree of compression, and so on.

Moreover, the stream may be transmitted through wired or wireless connection without being stored in the storage medium.

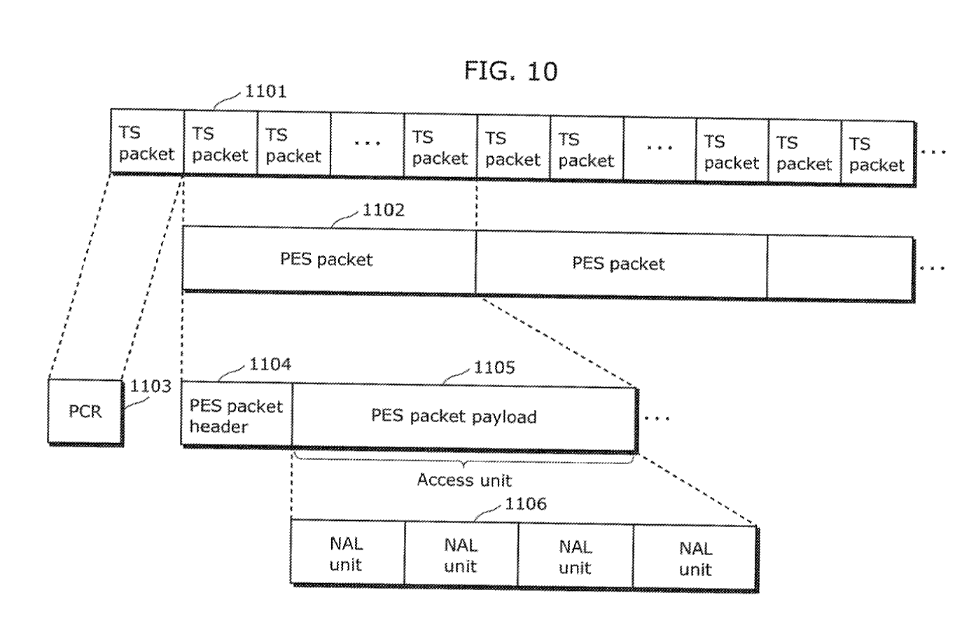

FIG. 10 is a diagram showing a structure of MPEG2-TS (Transport Stream) recorded onto a recording medium, as a more specific example of the present embodiment in which the video data and the flag regarding the color gamut compression or the color gamut compression parameter are transmitted.

The MPEG2-TS shown in FIG. 10 includes a fixed-length packet called a TS packet 1101. A PES (Packetized Elementary Stream) packet 1102 in which video or audio data is stored, reference clock information called PCR (Program Clock Reference) 1103, and the like are transmitted in the TS packet 1101.

A PES packet header 1104 of the PES packet 1102 stores information called PTS (Presentation Time Stamp) and DTS (Decoding Time Stamp) which respectively indicate presentation timing and decoding timing of access units that are decoding units of video or audio stored in a PES packet payload 1105.

Each of the access units of the video data includes coded data of one picture, and includes units of information called NAL (Network Abstraction Layer) units 1106 which store information such as image data of pictures included in a coded stream, a parameter used for image decoding such as SPS (Sequence Parameter Set) and PPS (Picture Parameter Set), and SEI (Supplemental Enhancement Information) including additional information such as timing information of each picture.

Furthermore, a header of each NAL unit includes information (nal_ref_idc) indicating whether or not data which can be referred to by another NAL unit is included in a NAL unit.

The NAL unit has VUI (Video Usability Information), and stores color primary information and matrix information.

Accordingly, the flag regarding the color gamut compression and the color gamut compression parameter can be stored in the above SEI, VUI, or the like, and transmitted.

Moreover, the flag and the color gamut compression parameter can be stored in management information of the whole stream, but it is preferable to add the flag and the color gamut compression parameter to information cyclically transmitted such as the above SEI and VUI.

When the flag and the color gamut compression parameter are recorded onto the recording medium as files, the MPEG2-PS (Program Stream) is used. However, the same holds true for this case. Moreover, a compression method may be VC-1 which is the moving picture compression standard, and may be any method.

Moreover, the flag and the color gamut compression parameter do not always need to be stored in an MPEG file or a stream itself, and can be stored in upper management information such as management information of a DVD or BD disc and EPG information.

### Embodiment 2

The following describes a video displaying apparatus according to Embodiment 2. Embodiment 2 is an embodiment relating to the video displaying apparatus which displays video data having a wide color gamut which has been recorded and transmitted in a luminance and chrominance format such as an xvYCC format. Actual application includes devices such as televisions, PDP devices, and cinema projectors which convert the luminance and chrominance format into a display signal and display the display signal.

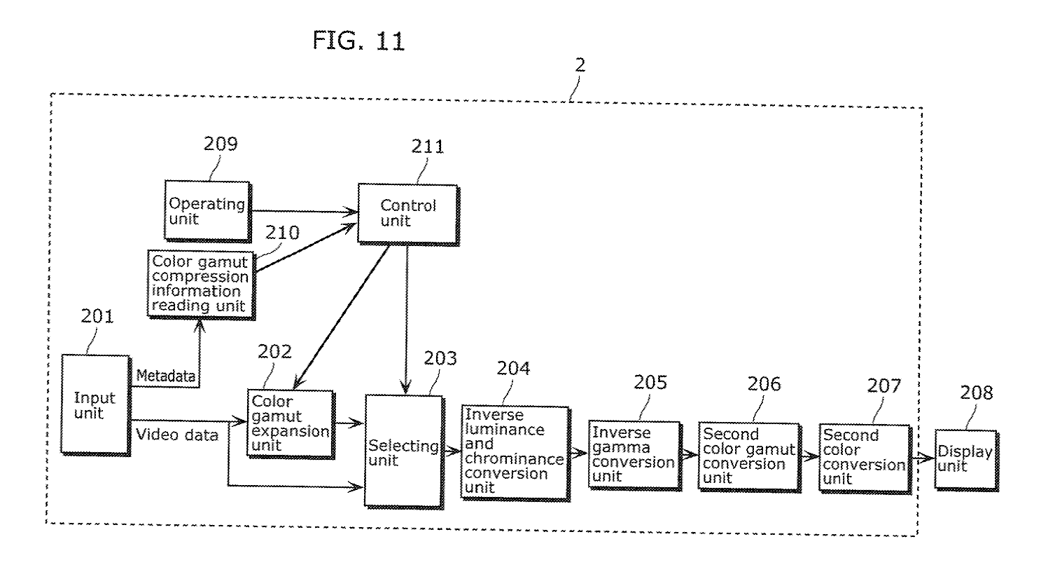

FIG. 11 is a block diagram showing a functional structure of the video displaying apparatus according to Embodiment 2.

As shown in the diagram, the video displaying apparatus includes a display unit 208 and a signal processing unit 2.

The display unit 208 is a display Unit which visualizes a signal processed by the signal processing unit 2. The display unit 208 is the display unit which allows display of the DCI color gamut or a wide color gamut similar to the DCI color gamut.

The signal processing unit 2 is a processing unit which receives video data represented by an xvYCC color gamut and drives the display unit 208. As shown in the diagram, the signal processing unit 2 includes: an input unit 201; a color gamut expansion unit 202; a selecting unit 203; an inverse luminance and chrominance conversion unit 204; an inverse gamma conversion unit 205; a second color gamut conversion unit 206; a second color conversion unit 207; an operating unit 209; a color gamut compression information reading unit 210; and a control unit 211.

The input unit 201 receives a luminance signal and a chrominance signal as well as a flag that is information indicating that the received chrominance signal has been converted or information indicating a conversion coefficient showing a predetermined ratio. More specifically, the input unit 201 receives video data represented by the xvYCC color gamut either from a recording medium such as a Blu-ray (trademark) disc, a DVD, a hard disk, and a memory card or from an external device which is connected to the video displaying apparatus, using a transmission standard such as HDMI and WiHD.

The color gamut expansion unit 202 expands, among received chrominance signals, chrominance signals which are outside a value range that can be represented by a BT. 709 color gamut and which are included in chrominance signals in a value range that can be represented by the xvYCC color gamut, into a value before compression, using the predetermined ratio. More specifically, in the case where there is a flag, the color gamut expansion unit 202 performs arithmetic processing on the chrominance signals using a predetermined conversion coefficient, and expands the chrominance signals into a value range that can be represented by the DCI color gamut or a value range that can be represented by a color gamut wider than the DCI color gamut. Furthermore, in the case where the conversion coefficient is accumulated in the recording medium, the expansion is performed using the accumulated conversion coefficient in the same manner as in the case where there is the flag.

The selecting unit 203 determines whether or not the color gamut is to be expanded. More specifically, when the input unit 201 receives the flag or the information indicating the conversion coefficient, a signal outputted from the color gamut expansion unit 202 is used, but otherwise signal selection is performed so that a signal outputted from the input unit 201 is directly used.

The inverse luminance and chrominance conversion unit 204 converts a chrominance signal and a luminance signal that are outputted from the selecting unit 203 into a color signal. More specifically, the inverse luminance and chrominance conversion unit 204 converts the luminescence signal and the chrominance signal that are defined in xvYCC into a color signal of BT. 709 primaries (R, G, and B) that are represented by the xvYCC color gamut.

The inverse gamma conversion unit 205 converts the converted color signal into a second color signal, according to an inverse gamma characteristic defined by a range wider than a possible value range of the luminance signal and the chrominance signal that can be represented by the BT. 709 color gamut. More specifically, the inverse gamma conversion unit 205 performs the conversion through the inverse gamma correction defined in the xvYCC so that an input signal of a negative value or a value above 1 can be processed.

The second color gamut conversion unit 206 and the second color conversion unit 207 convert the color signal converted by the inverse gamma conversion unit 205 into a color signal that can be displayed on a display device.

More specifically, the second color gamut conversion unit 206 limits (performs color gamut conversion), to a color gamut of the display device, the color signal having the DCI color gamut represented by primaries having a negative value or a value above 1 on which the inverse gamma conversion has been performed.

Furthermore, the second color conversion unit 207 converts, into R, G, and B primaries unique to the display device, the BT. 709 primaries of R, G, and B which have been limited to the color gamut of the display device.

Here, a “color signal conversion unit” in Claims has the same functions as the second color gamut conversion unit 206 and the second color conversion unit 207.

Moreover, the color gamut compression information reading unit 210 extracts information indicating whether or not a color gamut has been compressed, information about a color gamut compression parameter, or the like which is added to the video data obtained from the input unit 201.

The operating unit 209 is an operating unit including a user interface.

The control unit 211 determines whether or not to expand a color gamut, and sets a parameter for the color gamut expansion, based on information of at least the color gamut compression information reading unit 210 and the operating unit 209.

The following describes the input unit 201 in detail.

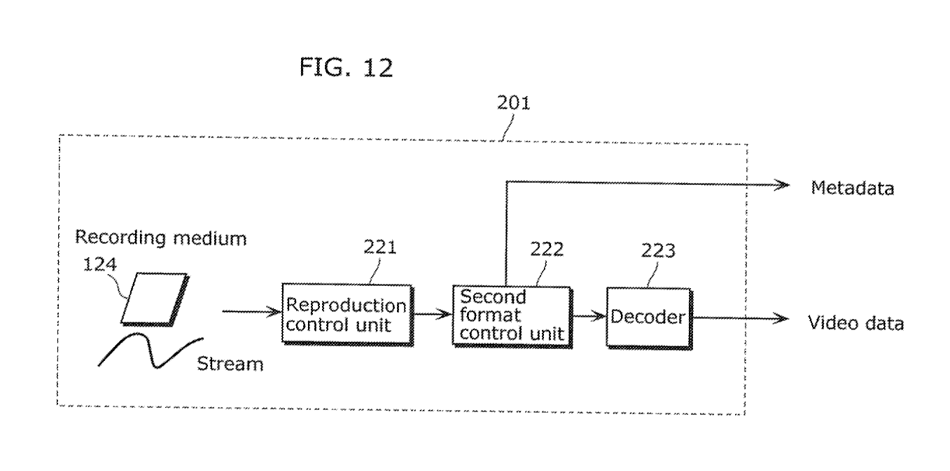

FIG. 12 is a diagram showing a specific structure of the input unit 201 which receives video data compressed by using a codec such as MPEG-2 and H.264.

A reproduction control unit 221 reproduces a file or a stream from a recording medium 124 such as a Blur-ray disc, a DVD, a hard disk, a memory, and a memory card. A second format control unit 222 analyzes compressed video data which is obtained from the file or the stream and is encoded by using a publicly known code such as MPEG-2 and H.264, extracts specific metadata from a management information storage unit such as a header, and separates the compressed video data itself. The specific metadata corresponds to, for example, color gamut compression information at the time of compressing a color signal into the xvYCC color gamut for the compressed video data.

A decoder 223 decodes the separated compressed video data, and converts the decoded data into an uncompressed video data.

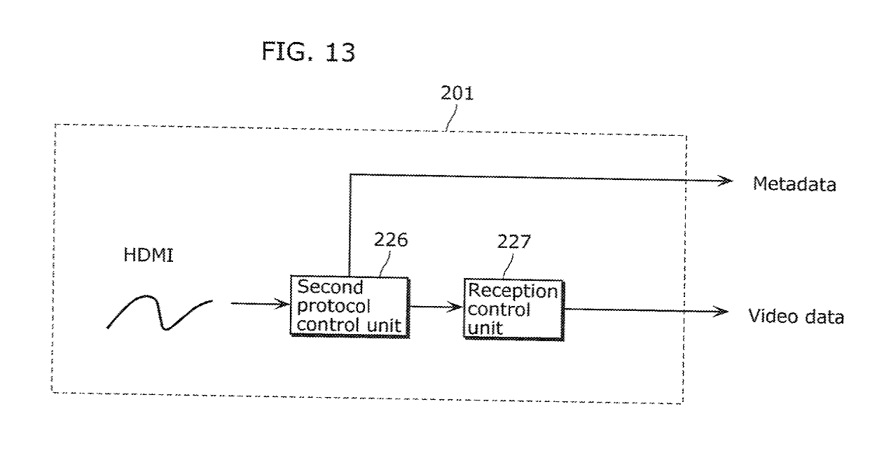

Similarly, FIG. 13 is a diagram showing a specific structure of the input unit 201 which receives video data transmitted through an uncompressed video interface such as HDMI.

A second protocol control unit 226 controls protocols of the interface, and obtains necessary information.

Furthermore, a reception control unit 227 receives the video data through the interface.

In this manner, the input unit 201 receives a flag stored in a header of a moving picture stream or a flag transmitted by using protocols of an external communication path.

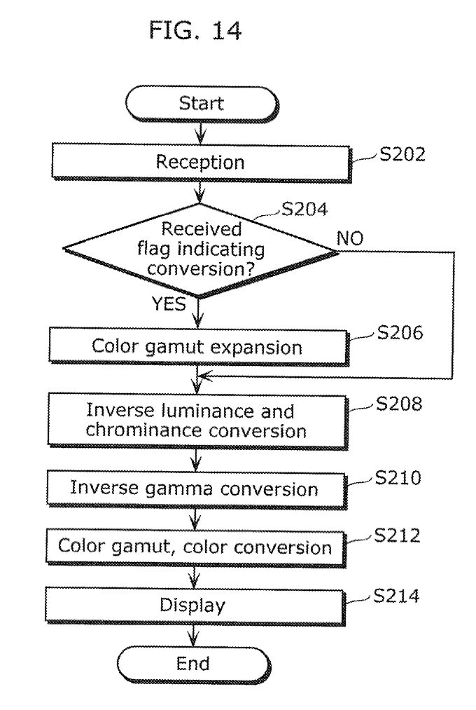

FIG. 14 is a flowchart showing an example of operations of the video displaying apparatus according to Embodiment 2.

First, the input unit 201 receives a luminance signal and a chrominance signal as well as a flag that is information indicating that the received chrominance signal has been converted, and information indicating a conversion coefficient showing a predetermined ratio (S202). The color gamut compression information reading unit 210 then extracts information such as the flag and the conversion coefficient received by the input unit 201.

Next, the control unit 211 determines whether or not the input unit 201 has received the flag indicating that the chrominance signal has been converted, based on the information of the color gamut compression information reading unit 210 (S204).

When the control unit 211 determines that the input unit 201 has received the flag (Yes in S204), the color gamut expansion unit 202 expands the chrominance signal based on the conversion coefficient (S206).

More specifically, the color gamut expansion unit 202 expands, among received chrominance signals, each of a Cr signal and a Cb signal, using a different ratio. Moreover, the color gamut expansion unit 202 expands each of a positive Cr signal and a negative Cr signal which are Cr signals, within a possible value range of the Cr signal, outside a value range that can be represented by the BT. 709 color gamut, using a different ratio. Further, the color gamut expansion unit 202 expands each of a positive Cb signal and a negative Cb signal which are Cb signals, within a possible value range of the Cb signal, outside a value range that can be represented by the BT. 709 color gamut, using a different ratio.

The inverse luminance and chrominance conversion unit 204 then converts the expanded chrominance signal and the received luminance signal into a color signal (S208).

Furthermore, when the control unit 211 determines that the input unit 201 has not received the flag (No in S204), the selecting unit 203 determines that the color gamut is not to be expanded, and the inverse luminance and chrominance conversion unit 204 converts the received chrominance signal and luminance signal into a color signal (S208).

Next, the inverse gamma conversion unit 205 converts the converted color signal into a second color signal according to an inverse gamma characteristic (S210).

The second color gamut conversion unit 206 and the second color conversion unit 207 then convert the second signal into a color signal that can be displayed on a display device (S212).

The display unit 208 then displays a video on the display device based on the converted color signal (S214).

The following describes an example of specific operations according to the present embodiment. The description is based on an assumption that the display unit 208 performs display on a display device which can display a color gamut similar to or exceeding the DCI color gamut such as PDP, LCD, and organic EL.

The reproduction control unit 221 reads the compressed video data which is stored in the recording medium 124 and which is data of a video file compressed according to H.264, and transmits the compressed video data to the second format control unit 222. The second format control unit 222 extracts, from the compressed video data, metadata indicating whether or not a color gamut has been compressed or regarding a color gamut compression parameter which is stored in a header of H.264, and transmits the compressed video data to the decoder 223. The decoder 223 decodes the compressed video data into uncompressed video data, and outputs the uncompressed video data as video data.

Moreover, when the uncompressed interface such as HDMI is used, the second protocol control unit 226 first obtains and outputs, through protocols with a transmission side, the metadata indicating whether or not the color gamut has been compressed or regarding the color gamut compression parameter, and the reception control unit 227 receives and outputs the video data itself.

The color gamut expansion unit 202 expands, for the outputted video data in a luminance and chrominance format, a chrominance signal which is outside the value range of the BT. 709 color gamut and which is compressed within the value range of the xvYCC color gamut. The expanded chrominance signal exceeds a signal range (−0.57 to 0.56) that can be represented by the xvYCC color gamut, and thus it is necessary to upwardly extend one bit for the expanded chrominance signal and then process the chrominance signal.

The control unit 211 provides the color gamut compression parameter to the color gamut expansion unit 202 based on the instruction of the user by the operating unit 209 or the metadata regarding the color gamut compression which is obtained by the input unit 201 and the color gamut compression information reading unit 210. Furthermore, when the color gamut compression has not been performed, the selecting unit 203 selects video data on which color gamut expansion has not been performed.

More specifically, in the case where there is no flag indicating the color gamut compression or in the case where the metadata indicating the color gamut compression is not transmitted through the protocols, the selecting unit 203 selects the video data on which the color gamut expansion has not been performed.

Moreover, in the case where there is the flag indicating that the color gamut compression has not been performed or in the case where the metadata indicating that the color gamut compression has not been performed is transmitted through the protocols, the selecting unit 203 selects the video data on which the color gamut expansion has not been performed. It is to be noted that in the case where the metadata indicating the color gamut compression is not transmitted, the expansion may be performed based on a parameter preset on a display side.

In the case where there is the flag indicating the color gamut compression or in the case where the metadata indicating the color gamut compression is transmitted through the protocols, the selecting unit 203 causes the color gamut expansion unit 202 to select video data on which the color gamut expansion has been performed. Further, in the case where a level or a parameter of the color gamut compression is added, the color gamut expansion unit 202 performs the color gamut expansion based on such information.

In the case where image data having a wide color gamut is compressed by the color gamut compressing unit 106 described in Embodiment 1 of the present invention, the color gamut is expanded by using the inverse of the compression characteristics of the color gamut compressing unit 106. More specifically, the conversion is performed using the inverse shown in FIGS. 5 and 6.

Furthermore, in the case where the compression parameter of the color gamut compression is added, a characteristic parameter to be expanded is determined by calculating the inverse of the compression parameter using the compression parameter, and the expansion is performed.

The compression parameter may be defined by the actual compression characteristics such as coordinates or slope of a broken line, predefined codes indicating compression characteristics, a percentage of a compression range or a degree of compression, and so on.

The inverse luminance and chrominance conversion unit 204 converts, into an R, G, and B signal of the BT. 709 primaries, a luminance signal and a chrominance signal of the xvYCC on which the color gamut expansion is performed and which are restored to the DCI color gamut exceeding the xvYCC color gamut.

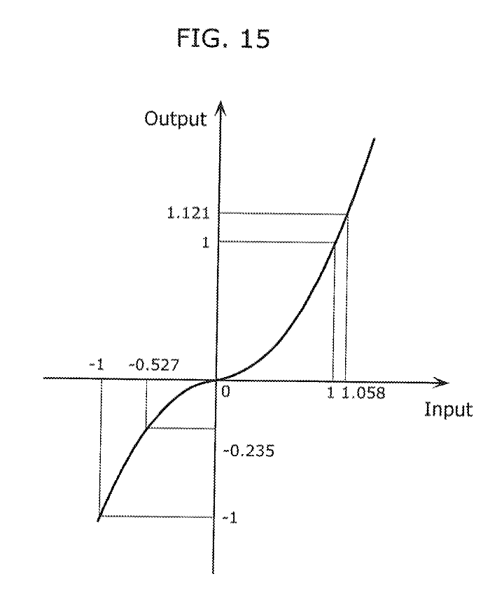

Next, the inverse gamma conversion unit 205 inversely corrects, through inverse gamma conversion, gamma applied to the R, G, and B, and converts the R, G, and B into linear R, G, and B. FIG. 15 is a diagram illustrating conversion characteristics of the inverse gamma conversion unit 205 which are defined in the xvYCC. The conversion characteristics expand a gamma characteristic of the BT. 709 beyond 1 and further with point symmetry for a negative value, and are defined by the following equations.

R₇₀₉=((R₇₀₉^{©}+0.099)/1.099)^{1.0/0.45} 0.081≦R₇₀₉^{©}

R₇₀₉=R₇₀₉^{©}/4.5 −0.081≦R₇₀₉^{©}<0.081

R₇₀₉=−((−R₇₀₉^{©}+0.099)/1.099)^{1.0/0.45} R₇₀₉^{©}<−0.081 [Math. 4]

The color signal linearized by the inverse gamma conversion unit 205 represents the DCI color gamut wider than the xvYCC color gamut by using a negative value or a value above 1 as a signal level of the BT. 709 primaries. However, the color gamut that can be displayed by the display device is determined by the R, G, and B primaries unique to a device in a three-primary-color display. Although the display device which can display at least colors that cannot be represented according to the xvYCC is assumed in the present embodiment, the display device does not necessarily cover the entire DCI color gamut.

The second color gamut conversion unit 206 naturally limits the DCI color gamut to the color gamut unique to the display device through a publicly known algorithm generally called gamut conversion. It is to be noted that the gamut conversion method may be any method which can limit a color gamut. Moreover, in the case where the color gamut displayed by the display unit 208 exceeds the DCI color gamut, the second color gamut conversion unit 206 is not necessary.

The second color conversion unit 207 converts, into the R, G, and B primaries unique to the display device, the R, G, and B limited to the color gamut of the display device by the second color gamut conversion unit 206. The R, G, and B are limited to the color gamut of the display device by the second color gamut conversion unit 206, and thus the R, G, and B converted by the second color conversion unit 207 each have a value 0 to 1 and can be represented by the display device.

The linear matrix shown below is normally used for the conversion. The primaries in the color gamut displayed by the display unit 208 are determined by a spectral distribution of a fluorescent material in the case of the PDP, a product of a spectral distribution of a color filter and a spectral distribution of a backlight in the case of a liquid crystal, and so forth, and a matrix coefficient can be determined based on a relationship between the primaries and the BT. 709 primaries. However, the matrix coefficient is often determined by an adjustment of color temperature of the display device or the like in an actual realized structure, and thus the matrix coefficient is not always determined in the manner described above. Here, for the sake of simplicity of description, a case where the primaries in the color gamut displayed by the display unit 208 match the DCI primaries is described as an example. In this case, the second color gamut conversion unit 206 is unnecessary.

$$( \begin{matrix}R \\ G \\ B\end{matrix} ) = ( \begin{matrix}0.898952 & 0.194049 & 0.000000 \\ 0.031821 & 0.926803 & 0.000000 \\ 0.019654 & 0.083296 & 1.047585\end{matrix} ) ( \begin{matrix}{R}_{709} \\ {G}_{709} \\ {B}_{709}\end{matrix} ) \qquad [ Math . 5 ]$$

Even when the R, G, and B of the BT. 709 on the right-hand side take the negative value or the value above 1, the above R, G, and B in the DCI color gamut having a wide color gamut are limited to the range of the DCI color gamut, and thus the R, G, and B on the left-hand side fall within the range of 0 to 1 and can be represented.

### Embodiment 3

The following describes a television receiver including a video displaying apparatus according to Embodiment 3. Embodiment 3 relates not only to faithfully displaying in correct color video data having a wide color gamut recorded and transmitted in a luminance and chrominance format such as an xvYCC format but also to a process performed when image reproduction for better representation required for a television is concurrently used.

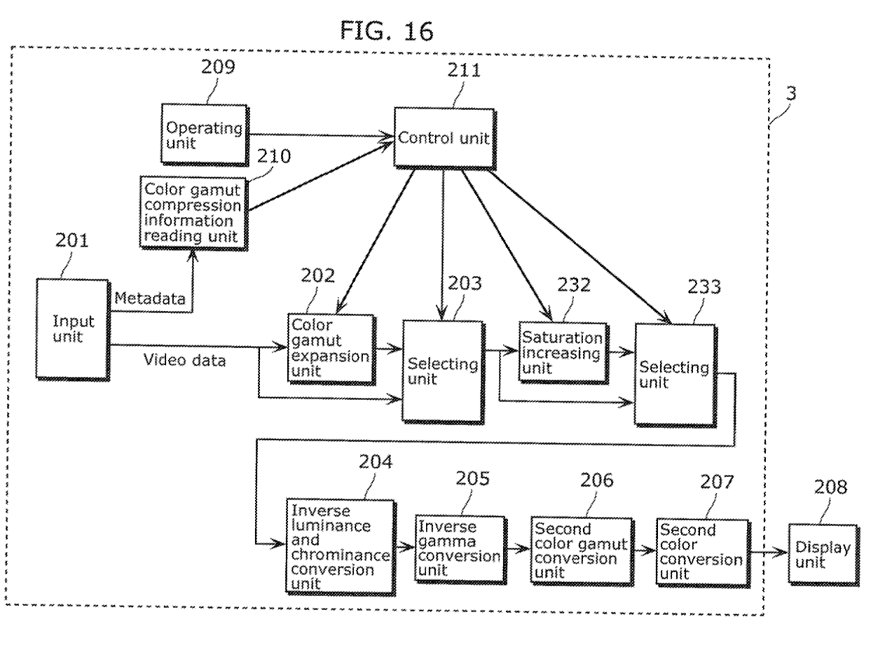

FIG. 16 is a block diagram showing a functional structure of the video displaying apparatus according to Embodiment 3.

As shown in the diagram, the video displaying apparatus according to the present embodiment includes a third signal processing unit 3 and a display unit 208. Furthermore, the third signal processing unit 3 includes a saturation increasing unit 232 and a selecting unit 233 in addition to each of the processing units included in the second signal processing unit 2 shown in FIG. 11. It is to be noted that each of the same processing units as the processing units shown in FIG. 11 has the same function as a corresponding one of the processing units shown in FIG. 11, and thus description thereof is omitted.

The saturation increasing unit 232 performs color gamut correction. More specifically, the saturation increasing unit 232 performs image reproduction for better representation. Here, a “color correction unit” in Claims has the same functions as the saturation increasing unit 232.

The selecting unit 233 turns ON or OFF the processing of the saturation increasing unit 232.

The control unit 211 controls a degree of increase of the saturation increasing unit 232 and a selection process of the selecting unit 233.

Conventionally developed consumer television receivers perform image reproduction in which saturation is increased more than faithfully to emphasize vividness. However, a color originally having high saturation reaches the limit of a color gamut of a display device and color saturation and tone saturation are caused when the saturation is emphasized, and thus there is a limit to the saturation emphasis. Here, using a display device having a wide color gamut, for example, a display device that can display the DCI color gamut, expands a range in which the saturation is emphasized as the image reproduction, and a degree of freedom is increased from a point of view of image reproduction for television.

On the other hand, it is expected to faithfully reproduce video data having a wide color gamut by utilizing the characteristics of the display device having the wide color gamut described above.

In order to address the contradictory demands, in the present embodiment, a “faithful mode” and an “image reproduction mode” are exemplified as image quality modes of television, and the user indicates one of the modes through the operating unit 209. The “faithful mode” is a mode in which video data having a wide color gamut is faithfully reproduced, and the “image reproduction mode” is a mode in which saturation is emphasized and better representation is realized.

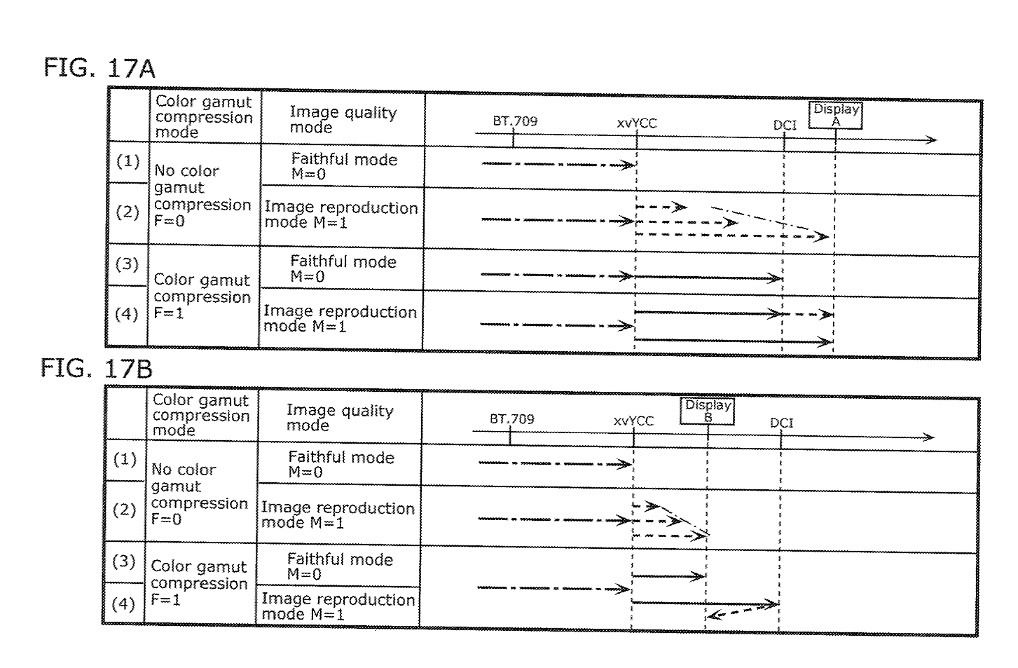

Each of FIG. 17A and FIG. 176 is a diagram illustrating functions of the video displaying apparatus according to Embodiment 3.

Each of the diagrams illustrates operations for combination of the above two image quality modes and a color gamut compression flag (whether or not the DCI color gamut is compressed within the xvYCC range) of an input signal, with respect to a television including a wide color gamut display device. The horizontal axis of each diagram conceptually indicates a relative size of a color gamut.

FIG. 17A shows operations in the case where the display device is Display A having a color gamut exceeding the DCI color gamut, and FIG. 17B shows operations in the case where the display device is Display B of which color gamut that can be displayed is narrower than the DCI color gamut. In the case where the video data is being read from, for instance, a recording medium, flag F is added to a header as metadata of the read video data. The flag F indicates whether or not a color signal represented in a color gamut wider than the DCI color gamut has been compressed into a color signal that can be represented within the xvYCC color gamut. F=1 indicates color gamut compression, and F=0 indicates no color gamut compression. Furthermore, a case where the video data includes no color gamut compression flag is indicated as F=0.

Likewise, flag M indicates one of the image quality modes. M=1 indicates the “image reproduction mode”, and M=0 indicates the “faithful mode”.

Next, operations for combination of each mode in the present embodiment are described. It is assumed in the present embodiment that the video data is obtained by imaging in the DCI color gamut and compressed into the xvYCC color gamut. It is to be noted that the obtainment of the video data is not limited by imaging in the DCI color gamut, and the video data may be obtained by imaging in any color gamut wider than a conventionally used color gamut such as the xvYCC color gamut.

First, the operations of the Display A (FIG. 17A) having a physical color gamut exceeding the DCI color gamut or having the same color gamut as the DCI color gamut are described.

(1) F=0, M=0: Case of no color gamut compression on input video data and faithful mode

Color Gamut Compression has not been Performed on Video Data to be inputted. Thus, the selecting unit 203 selects a signal for which a color gamut is not expanded. Image reproduction is not performed in the faithful mode, and thus the selecting unit 233 selects a signal for which saturation is not increased. As shown in FIG. 17A, a color gamut of an input signal (an alternate long and short dash arrow line) is not processed, the inputted video data is faithfully reproduced on the Display A, and the wide color gamut of the Display A is not used.

(2) F=0, M=1: Case of no color gamut compression on input video data and image reproduction mode

The color gamut compression has not performed on the video data to be inputted. Thus, the selecting unit 203 selects the signal for which the color gamut is not expanded, and the selecting unit 233 selects an output of the saturation increasing unit 232 for image reproduction. A design concept of image reproduction allows the degree of increase (a broken arrow line) of the saturation increasing unit 232 to have a freedom, for example, from little saturation increase similar to the faithful mode to saturation increase which uses up the color gamut of the Display A. The design concept may provide more numerous display modes (such as dynamic, cinema, and standard), and one of the display modes may be selectively used according to a corresponding one of image reproduction concepts.

(3) F=1, M=0: Case of color gamut compression on input video data and faithful mode

The DCI color gamut or the color gamut wider than the DCI color gamut has been compressed within the xvYCC color gamut. Thus, the selecting unit 203 selects video data on which the color gamut expansion unit 202 has performed the color gamut expansion, that is, a signal (a solid arrow line) for which the original DCI color gamut shown in FIG. 17A has been restored. In the case of FIG. 17A, the restored color gamut can be displayed by the Display A, and is thus faithfully displayed. There is a further margin in the color gamut of the Display A, but the margin is not used due to the emphasis on faithfulness.

(4) F=1, M=1: Case of color gamut compression on input video data and image reproduction mode

As in the above (3), the selecting unit 203 selects the video data (the solid arrow line) on which the color gamut expansion unit 202 has performed the color gamut expansion and for which the DCI color gamut has been restored. Further, the selecting unit 233 selects the output of the saturation increasing unit 232 for the image reproduction, and increases saturation. A range in which the saturation is then increased is set to a region that can be represented by the Display A (a dashed arrow line).

Implementation of the mode includes another modification.

The modification is a method for not faithfully expanding the color gamut to the DCI color gamut but expanding the color gamut to the color gamut of the Display A at once (a lower solid arrow line) as an expansion characteristic parameter of the color gamut expansion unit 202 selected by the selecting unit 203. Like the faithful mode in the above (3), this method is characterized in that the saturation increasing unit 232 and the selecting unit 233 are not necessary.

Next, the operations of the Display B (FIG. 17B) that have a physical color gamut exceeding the DCI color gamut and that can display a color gamut smaller than the DCI color gamut are described.

(1) F=0, M=0: Case of no color gamut compression on input video data and faithful mode

Like in FIG. 17A, the selecting unit 203 selects the signal for which the color gamut is not expanded, and the selecting unit 233 selects the signal for which the saturation is not increased. FIG. 17B shows that the color gamut indicated by the input signal (an alternate long and short dash arrow line) is faithfully reproduced on the Display B. The color gamut of the Display B is not used to the maximum.

(2) F=0, M=1: Case of no color gamut compression on input video data and image reproduction mode

Like in FIG. 17A, the selecting unit 203 selects the signal for which the color gamut is not expanded, and the selecting unit 233 selects the output of the saturation increasing unit 232. The design concept of image reproduction allows the degree of increase (a broken arrow line) of the saturation increasing unit 232 to have a less design freedom because the color gamut of the Display B is smaller than the color gamut of the Display A shown in FIG. 17A. In many cases, it is effective to expand the color gamut to the maximum color gamut of the Display B.

(3) F=1, M=0: Case of color gamut compression on input video data and faithful mode; and

(4) F=1, M=1: Case of color gamut compression on input video data and image reproduction mode

In FIG. 17B, the color gamut that can be represented by the display device is smaller than the DCI color gamut, and thus it is difficult even to completely reproduce the DCI color gamut, and it is more difficult to add image reproduction to the DCI reproduction. Therefore, there is no room for the image reproduction, and it is hard to identify a basic difference between the faithful mode and the image reproduction mode. Accordingly, the modes are not distinguished from each other in the present embodiment. The DCI color gamut or the color gamut wider than the DCI color gamut is compressed within the xvYCC color gamut in (3) and (4). Thus, the selecting unit 203 selects the signal (the solid arrow line) on which the color gamut expansion unit 202 has performed the color gamut expansion, however the control unit 211 sets the parameter such that the range of the color gamut expansion is fixed to not the original DCI color gamut but the color gamut that can be represented by the Display B.

Implementation of the mode includes still another modification.

After the color gamut is restored to the DCI color gamut (the lower solid arrow line), the color gamut expansion unit 202 can map, through the same publicly known color gamut conversion processing which is performed by the first color gamut conversion unit 102 in the aforementioned embodiment and which is not illustrated, color exceeding the color gamut of the Display B to the color gamut of the Display B (a reversed broken arrow line), in a visually natural manner. Although this method is disadvantageous in terms of cost because requirement of a new color gamut conversion unit which is not illustrated complicates a structure in comparison with the aforementioned method, a publicly known advanced method (Non Patent Literature: “Digital Hard Copy Technique”, Kyoritsu Shuppan Co., Ltd. pages 59 to 63) can be adapted by the color gamut conversion unit, and thus the method excels in image quality.

The present embodiment makes it possible to realize a television which can combine (a) an effect of ensuring consistency and compatibility with image reproduction by televisions which have not conventionally always aimed at faithful color reproduction and (b) an effect of newly and faithfully reproducing colors in a wide color gamut of digital cinema. For instance, in the case of a regular television broadcast recorded in a studio, using the “image reproduction mode” enables image reproduction in which a color gamut is used up to the limit of a display device included in a television, regardless of whether or not a color gamut compression has been performed on video data.

Furthermore, in the case where video data to be inputted is data having a wide color gamut on which color gamut compression has been performed, a range to be used in the image reproduction by the television is automatically reduced, and thus there is also an effect of approximating color reproduced by the image reproduction to correct color.

Moreover, in the case where the video data to be inputted is data represented by the conventional xvYCC color gamut, the video data is faithfully reproduced in the value range of the xvYCC color gamut in the faithful mode, and in the case where the video data to be inputted is video data having a wide color gamut on which color gamut compression has been performed, it is possible to realize a television which allows faithful reproduction up to, for example, the DCI color gamut.

It is to be noted that the image reproduction is not limited to the emphasis on saturation. For instance, correction of memory color (a color correction process in which a human sense of preferring reproduction of colors memorized by humans such as the blue of the sky, the green of the trees, and the skin colors of humans to faithful reproduction is used) and the like are often used as the image reproduction.

As described above, the color gamut expansion unit 202 may expand the chrominance signal up to the color gamut that can be displayed on the display device, or after the color gamut expansion unit 202 expands the chrominance signal, the saturation increasing unit 232 may correct the color gamut according to the color gamut of the display device. Furthermore, the saturation increasing unit 232 may expand the color gamut in a linear manner or nonlinear manner. Further, the expansion range of the saturation increasing unit 232 is not limited.

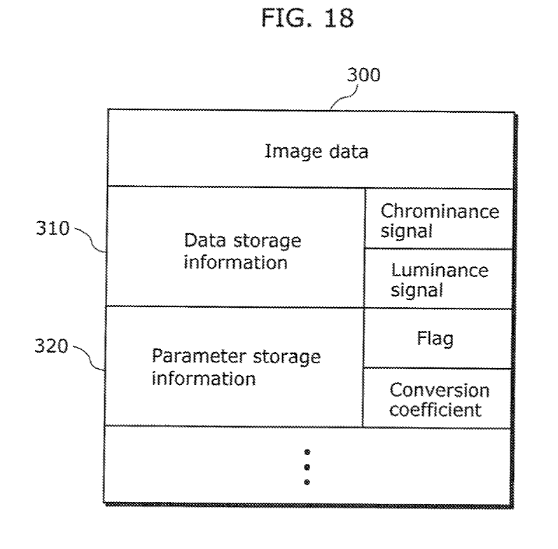

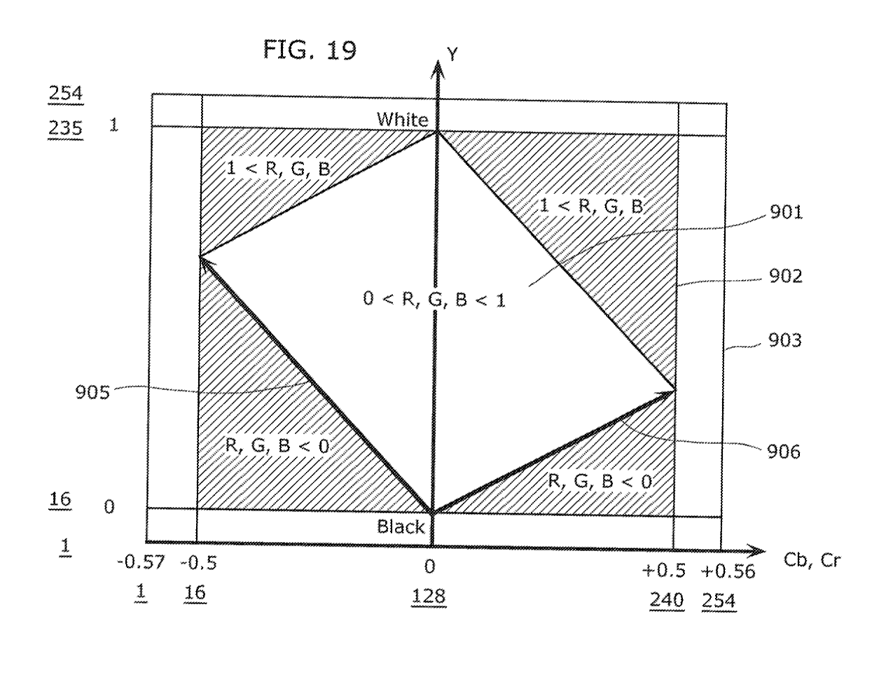

FIG. 18 is a diagram showing an example of image data 300 for recording or transmitting a luminescence signal and a chrominance signal of a color signal.

The image data 300 is data which is outputted by the output unit 108 included in the first signal processing unit 1 of the color signal converting apparatus and which is inputted to the input unit 201 included in the second signal processing unit 2 of the video displaying apparatus. As shown in the diagram, the image data 300 includes data storage information 310 and parameter storage information 320.

The data storage information 310 includes a chrominance signal and a luminance signal of video data outputted by the output unit 108.

The parameter storage information 320 includes (i) a flag that is information indicating whether or not the color gamut compressing unit 106 has performed conversion on the chrominance signal and (ii) information indicating a conversion coefficient.

As stated above, the image data 300 includes the flag and the conversion coefficient, and thus the video displaying apparatus makes it possible to display a video in the DCI color gamut or the wider color gamut similar to the DCI color gamut, based on the flag and the conversion coefficient of the inputted image data 300.

### Other Embodiments

Each of the functional blocks described in Embodiments 1 to 3 of the present invention may be implemented in hardware using, for example, an integrated circuit integral with a signal processing function of another camera or a display device, or may be implemented in embedded software using a central processing unit (hereinafter, referred to as a “CPU”) included in the integrated circuit. In addition, each functional block may be implemented as application software of an independent computer such as an authoring system for DVD or BD. Each of the various functions may be achieved by mixed processing of the software and the hardware.

First, in the case where each of the various functions is implemented in the hardware, each function described in each embodiment may be individually formed as the integrated circuit, or may be formed as a single chip integrated circuit so as to include a part or all thereof.

It is to be noted that the integrated circuit is not limited to an LSI, and may be referred to as an IC, a system LSI, a super LSI, and an ultra LSI due to a difference in the degree of integration.

Furthermore, the integrated circuit may be realized by a dedicated circuit or a general-purpose processor. For instance, it is also acceptable to use an FPGA (Field Programmable Gate Array) that is programmable after a semiconductor chip is manufactured, and a reconfigurable processor in which connections and settings of cells within the integrated circuit are reconfigurable.

Moreover, if integrated circuit technology appears through progress in semiconductor technology or other derived technology, that technology can naturally be used to carry out integration of the functional blocks. Application of biocomputer through progress in biotechnology is one such possibility.

Furthermore, the application software may be not only distributed as being stored in, for example, a disk, but also be downloaded via a network.

Moreover, a portion of the description in which the video camera is assumed in the above embodiment is not limited to this, and, in a similar idea, even digital cameras which capture still images allow transmission of a wide color gamut only when a video format is changed from the xvYCC having the BT. 709 primaries to sYCC having sRGB primaries and the DCI having a wide color gamut is replaced with an OP-RGB (equivalent to AdobeRGB) having a wide color gamut. Accordingly, the present invention can be applied to digital cameras.

Therefore, the signal processing unit according to each of the embodiments of the present invention can be applied to digital cameras such as still cameras which capture still objects and video cameras which capture moving objects, monitoring cameras which monitor objects, mobile phones including an imaging function, information apparatuses including the imaging function, integrated circuits for imaging, and so forth.

It is to be noted that although the case of HDTV has been described as the example using the BT. 709, in the case of SDTV, BT. 601 may be used in the same manner. Furthermore, although the Cb signal and the Cr signal are described, these are two representations of chrominance signal, and there are many representations of the same such as Pb, Pr, U, and V. Any representation can be used in the same manner, though a possible range of a value slightly changes.

It is to be noted that the specific structures of the present invention are not limited to each of the above embodiments, and can be altered and modified in various ways within the scope of the gist of the present invention. In addition, each of the components in the above embodiments can be arbitrarily combined within the scope of the gist of the present invention.

### INDUSTRIAL APPLICABILITY

The color signal converting apparatus and the video displaying apparatus according to the present invention allow transmission of an extremely wide color gamut which has not been achieved by expansion to the conventional wide color gamut format, while ensuring compatibility with the existing consumer video signal form. This made it possible to store, in a DVD or a BD, contents in a wide color gamut such as a movie, while having compatibility with the conventional devices, and to transmit the contents through, for instance, the HDMI interface to display devices, while ensuring the compatibility with the conventional devices. In addition, the color signal converting apparatus and the video displaying apparatus make it possible to realize wide color gamut display devices and televisions having the compatibility with the conventional devices, cameras capturing the wide color gamut, and so forth.

### REFERENCE SIGNS LIST

1 First signal processing unit
2 Second signal processing unit
3 Third signal processing unit
101 Imaging unit
102 First color gamut conversion unit
103 First color conversion unit
104 Gamma conversion unit
105 Luminance and chrominance conversion unit
106 Color gamut compressing unit
107 Selecting unit
108 Output unit
109 Operating unit
110 Color gamut determining unit
111 Control unit
112 Additional information generating unit
121 Encoder
122 Format control unit
123 Recording control unit
126 Transmission control unit
127 Protocol control unit
201 Input unit
202 Color gamut expansion unit
203 Selecting unit
204 Inverse luminance and chrominance conversion unit
205 Inverse gamma conversion unit
206 Second color gamut conversion unit
207 Second color conversion unit
208 Display unit
209 Operating unit
210 Color gamut compression information reading unit
211 Control unit
221 Control unit
222 Second format control unit
223 Decoder
226 Second protocol control unit
227 Reception control unit
232 Saturation increasing unit
233 Selecting unit
300 Image data
310 Data storage information
320 Parameter storage information
901 BT. 709 color gamut
902 BT. 709 region
903 xvYCC region
905, 906 BT. 709 primaries
907, 908 DCI primaries
909 DCI color gamut

1. A color signal converting apparatus which performs conversion on a first color signal represented in a first color gamut, said color signal converting apparatus comprising:
a primary color conversion unit configured to convert the first color signal into a second color signal represented in a second color gamut which is wider than a predetermined color gamut defined by predetermined standard primary color points and which includes the predetermined standard primary color points;
a gamma conversion unit configured to perform conversion on the second color signal according to a gamma characteristic;
a luminance and chrominance conversion unit configured to convert, into a luminance signal and a chrominance signal, the second color signal converted by said gamma conversion unit;
a chrominance signal conversion unit configured to convert, based on a conversion coefficient, the chrominance signal which is, within a possible value range of the chrominance signal, outside a value range that can be represented by the second color gamut, into a chrominance signal in a color gamut which is wider than the predetermined color gamut and narrower than the second color gamut; and
an output unit configured to output, as an output signal, the chrominance signal converted by said chrominance signal conversion unit and the luminance signal converted by said luminance and chrominance conversion unit.

2. The color signal converting apparatus according to claim 1,
wherein said chrominance signal conversion unit is configured to perform the conversion on the chrominance signal by multiplying a value indicating chrominance of the chrominance signal by the conversion coefficient.

3. The color signal converting apparatus according to claim 1,
wherein said chrominance signal conversion unit is configured to perform conversion on each of a Cr signal and a Cb signal included in the chrominance signal, using a different conversion coefficient.

4. The color signal converting apparatus according to claim 3,
wherein said chrominance signal conversion unit is configured to perform conversion on each of a positive Cr signal and a negative Cr signal which are Cr signals, within a possible value range of the Cr signal, outside a positive value range and a negative value range of the Cr signal which are defined by the second color signal, using the different conversion coefficient.

5. The color signal converting apparatus according to claim 3,
wherein said chrominance signal conversion unit is configured to perform conversion on each of a positive Cb signal and a negative Cb signal which are Cb signals, within a possible value range of the Cb signal, outside a positive value range and a negative value range of the Cb signal which are defined by the second color signal, using the different conversion coefficient.

6. The color signal converting apparatus according to claim 1,
wherein said chrominance signal conversion unit is configured to perform the conversion on the chrominance signal based on a conversion coefficient set according to arbitrary two points between a first endpoint of a possible value range of the chrominance signal in the predetermined color gamut and a second endpoint of a possible value range of the chrominance signal in the second color gamut inclusive.

7. The color signal converting apparatus according to claim 6,
wherein said chrominance signal conversion unit is configured to perform the conversion on the chrominance signal based on a conversion coefficient set according to the first endpoint and the second endpoint.

8. The color signal converting apparatus according to claim 1, further comprising:
a color gamut determining unit configured to determine whether or not a color gamut is the first color gamut; and
a control unit configured to decide the conversion coefficient based on a result of the determination by said color gamut determining unit,
wherein said control unit is configured to change the conversion coefficient according to a change in the first color gamut.

9. The color signal converting apparatus according to claim 1, further comprising:
a color gamut determining unit configured to determine whether or not a color gamut is the first color gamut;
a control unit configured to determine whether or not to perform the conversion on the chrominance signal, based on a result of the determination by said color gamut determining unit; and
an additional information generating unit configured to generate a flag which is information indicating whether or not said chrominance signal conversion unit has performed the conversion on the chrominance signal,
wherein, in the case where said control unit determines to perform the conversion on the chrominance signal, said chrominance signal conversion unit is configured to perform the conversion on the chrominance signal, and said additional information generating unit is configured to generate the flag.

10. The color signal converting apparatus according to claim 1,
wherein said output unit is further configured to output information indicating the conversion coefficient.

11. The color signal converting apparatus according to claim 10,
wherein, when the output signal is multiplexed with another information in a moving picture stream, said output unit is configured to store the information indicating the conversion coefficient in a header of the moving picture stream, and output the stored information.

12. The color signal converting apparatus according to claim 10,
wherein, in the case where the output signal is multiplexed with another information in a moving picture stream and the multiplexed output signal is written onto a recording medium, said output unit is configured to store the information indicating the conversion coefficient in management information of the recording medium, and output the stored information.

13. The color signal converting apparatus according to claim 10,
wherein, in the case where the output signal is multiplexed with another information in a moving picture stream and the multiplexed output signal is transmitted to an external communication path, said output unit is configured to output the information indicating the conversion coefficient through transmission using a protocol of the communication path.

14. The color signal converting apparatus according to claim 1,
wherein said output unit is further configured to output a flag which is information indicating whether or not said chrominance signal conversion unit has performed the conversion on the chrominance signal.

15. The color signal converting apparatus according to claim 14,
wherein, when the output signal is multiplexed with another information in a moving picture stream, said output unit is configured to store the flag in a header of the moving picture stream, and output the stored flag.

16. The color signal converting apparatus according to claim 14,
wherein, in the case where the output signal is multiplexed with another information in a moving picture stream and the multiplexed output signal is written onto a recording medium, said output unit is configured to store the flag in management information of the recording medium, and output the stored flag.

17. The color signal converting apparatus according to claim 14,
wherein, in the case where the output signal is multiplexed with another information in a moving picture stream and the multiplexed output signal is transmitted to an external communication path, said output unit is configured to output the flag through transmission using a protocol of the communication path.

18. A video displaying apparatus which performs conversion on a luminance signal and a chrominance signal of a color signal and displays a video on a display device, said video displaying apparatus comprising:
an input unit configured to receive a luminance signal and a chrominance signal;
a color gamut expansion unit configured to expand, among received chrominance signals including the chrominance signal, a chrominance signal in a color gamut wider than a first color gamut and narrower than a second color gamut, at a predetermined ratio;
an inverse luminance and chrominance conversion unit configured to convert the expanded chrominance signal and the received luminance signal into a color signal;
an inverse gamma conversion unit configured to perform conversion on the color signal converted by said inverse luminance and chrominance conversion unit, according to an inverse gamma characteristic;
a color signal conversion unit configured to convert the color signal converted by said inverse gamma conversion unit into a color signal which can be displayed on the display device; and
a display unit configured to display a video on the display device based on the color signal converted by said color signal conversion unit.

19. The video displaying apparatus according to claim 18,
wherein said input unit is further configured to receive a flag which is information indicating that the received chrominance signal has been converted, and
said color gamut expansion unit is configured to expand the chrominance signal in the color gamut wider than the first color gamut and narrower than the second color gamut, only in the case where said input unit receives the flag.

20. The video displaying apparatus according to claim 18,
wherein said input unit is further configured to receive information indicating a conversion coefficient showing the predetermined ratio, and
said color gamut expansion unit is configured to expand the chrominance signal based on the conversion coefficient.

21. The video displaying apparatus according to claim 19,
wherein said input unit is configured to receive the flag stored in a header of a moving picture stream.

22. The video displaying apparatus according to claim 19,
wherein said input unit is configured to receive the flag transmitted using a protocol of an external communication path.

23. The video displaying apparatus according to claim 18,
wherein said color gamut expansion unit is configured to expand each of a Cr signal and a Cb signal included in the received chrominance signal, using a different ratio.

24. The video displaying apparatus according to claim 23,
wherein said color gamut expansion unit is configured to expand each of a positive Cr signal and a negative Cr signal which are Cr signals, within a possible value of the Cr signal, outside a value range of the first color gamut, using the different ratio.

25. The video displaying apparatus according to claim 23,
wherein said color gamut expansion unit is configured to expand each of a positive Cb signal and a negative Cb signal which are Cb signals, within a possible value range of the Cb signal, outside a value range of the first color gamut, using the different ratio.

26. The video displaying apparatus according to claim 18,
wherein said color gamut expansion unit is configured to expand the chrominance signal up to a color gamut which can be displayed by the display device.

27. The video displaying apparatus according to claim 18, further comprising
a color correction unit configured to correct a color gamut,
wherein said color correction unit is configured to perform color gamut correction in conformity with a color gamut of the display device after said color gamut expansion unit expands the chrominance signal.

28. Image data for recording or transmitting a luminance signal and a chrominance signal of a color signal, said image data comprising:
data storage information which includes the chrominance signal and the luminance signal outputted by the output unit according to claim 1; and
parameter storage information which includes (i) a flag which is information indicating whether or not the chrominance signal conversion unit according to claim 1 has performed the conversion on the chrominance signal and (ii) information indicating a conversion coefficient.

29. A color signal converting method for performing conversion on a first color signal represented in a first color gamut, said color signal converting method comprising:
converting the first color signal into a second color signal represented in a second color gamut which is wider than a predetermined color gamut defined by predetermined standard primary color points and which includes the predetermined standard primary color points;
performing conversion on the second color signal according to a gamma characteristic;
converting, into a luminance signal and a chrominance signal, the second color signal converted in said performing of conversion on the second color signal;
converting, based on a conversion coefficient, the chrominance signal which is, within a possible value range of the chrominance signal, outside a value range that can be represented by the second color gamut, into a chrominance signal in a color gamut which is wider than the predetermined color gamut and narrower than the second color gamut; and
outputting, as an output signal, the chrominance signal converted in said converting of the chrominance signal and the luminance signal converted in said converting of the second color signal.

30. A video displaying method for performing conversion on a luminance signal and a chrominance signal of a color signal and displaying a video on a display device, said video displaying method comprising:
receiving a luminance signal and a chrominance signal;
expanding, among received chrominance signals including the chrominance signal, a chrominance signal in a color gamut wider than a first color gamut and narrower than a second color gamut, at a predetermined ratio;
converting the expanded chrominance signal and the received luminance signal into a color signal;
performing conversion on the color signal converted in said converting of the expanded chrominance signal, according to an inverse gamma characteristic;
converting the color signal converted in said performing of conversion into a color signal which can be displayed on the display device; and
displaying a video on the display device based on the color signal converted in said converting of the color signal.
